(19) United States
(12) Patent Application Publication
(10) Pub. No.: US 2022/0289377 A1
(43) Pub. Date: Sep. 15, 2022

(54) AUTONOMOUS PLACEMENT OF AN AERIALLY-MOUNTABLE ELECTRONIC DEVICE

(71) Applicant: Ubicquia, Inc., Fort Lauderdale, FL (US)

(72) Inventors: Ian B. Aaron, Fort Lauderdale, FL (US); Claudio Santiago Ribeiro, Evanston, IL (US); Mohammed Mansour Ghomeshi, Fort Lauderdale, FL (US); Peter Aloumanis, Boca Raton, FL (US); Gustavo Dario Leizerovich, Aventura, FL (US)

(73) Assignee: Ubicquia, Inc., Fort Lauderdale, FL (US)

(21) Appl. No.: 17/680,186

(22) Filed: Feb. 24, 2022

Related U.S. Application Data
(60) Provisional application No. 63/153,841, filed on Feb. 25, 2021.

(51) Int. Cl. B64C 39/02; G05D 1/10

(52) U.S. Cl. CPC B64C 39/024; G05D 1/101; F21S 8/086

(57) ABSTRACT

An autonomous placement device for securing an electronic device to and/or removing an electronic device from an object (such as, for example, a utility pole or a streetlight luminaire optionally forming a part thereof) includes a repository and a remove-and-place system. The repository is arranged to store at least one electronic device. The remove-and-place system is operable, in one embodiment, to retrieve an electronic device from the repository and, after the autonomous placement device has been positioned proximate an aerial placement position, secure the electronic device to the object at the aerial placement position. The autonomous placement device may further include a guidance system operable to locate the aerial placement position prior to aerial positioning. The autonomous placement device may form part of a system, which also includes an unmanned aerial vehicle (UAV) and a payload coupling system that mechanically couples the autonomous placement device to the UAV.

### CROSS-REFERENCE TO RELATED APPLICATIONS

The present application claims priority upon and the benefit of U.S. Provisional Application No. 63/153,841, which was filed on Feb. 25, 2021, and is incorporated herein by reference in its entirety.

### TECHNICAL FIELD

The present disclosure relates generally to the placement of an electronic device at an aerial location. More particularly, but not exclusively, the present disclosure relates to the autonomous placement of an electronic device at an aerial location, such as on a streetlight luminaire, a streetlight pole, a utility pole, or a support member coupled to a utility pole.

### BACKGROUND

Utility poles are known throughout the world. In many cases, utility poles are arranged to carry electric powerlines, television programming and network cable, roadway lighting, and other public infrastructure. Sometimes, when a utility pole is proximate a roadway, parking lot, or the like, the utility pole will also support a streetlight. The streetlight includes a luminaire, which may be positioned on a support member or arm that is physically coupled to the utility pole.

FIG. 1 is a conventional installation or maintenance operation 10 performed on a utility pole 12. The utility pole 12 has a support arm 14, and a streetlight luminaire 16 affixed to the distal and of the support arm 14. In the operation 10, a bucket truck 18 has parked alongside the utility pole 12. The boom 20 of the bucket truck 18 has been raised, and a utility worker 22 is working from the bucket 24. In the operation 10 of FIG. 1, the utility worker 22 will be replacing a first control or monitoring device 26a that is installed atop the streetlight luminaire 16. Second and third control or monitoring devices 26b, 26c are held by the utility worker 22. At some point in the operation 10, the utility worker 22 will remove the first control or monitoring device 26a from the luminaire 16 and replace it with one or both of the second and third control or monitoring devices 26b, 26c. During the operation traffic 28a is stopped.

In order to carry out the installation or maintenance operation 10, the conventional workflow requires: 1) approval from one or more governmental authorities, 2) closing all or at least a portion of the roadway proximate the utility pole 12 and streetlight 16 of interest, 3) rolling the bucket truck 18 into position, 4) positioning a human worker 22 in the bucket of the bucket truck, 5) raising the bucket to aerially position the worker next to the streetlight 16, 6) manually removing an existing controller 26a (if one is present) and placing the new controller 26b, 26c, 7) returning the worker 22 to ground level, and 8) restoring traffic flow on the roadway.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

The following is a summary of the present disclosure to provide an introductory understanding of some features and context. This summary is not intended to identify key or critical elements of the present disclosure or to delineate the scope of the disclosure. This summary presents certain concepts of the present disclosure in a simplified form as a prelude to the more detailed description that is later presented.

The device, method, and system embodiments described in this disclosure (i.e., the teachings of this disclosure) enable autonomous placement of a device on a utility pole. The device is a control or monitoring device mechanically or electromechanically coupled to a streetlight or some other part of a utility pole or utility grid infrastructure (e.g., a vault, a light mounted to a building or other structure, a high-tension powerline tower, or the like).

In contrast to the conventional operation (FIG. 1), the inventors envision that the teaching in the present disclosure will enable autonomous removal, placement, maintenance, and other acts associated with control and monitoring devices. In many cases, the autonomous acts may be performed without permits, without closing roadways, without deploying bucket trucks, and without many other inefficiencies of the conventional operations. Instead, an autonomous placement device, as taught herein, can safely, quickly, and efficiently perform tasks associated with utility grid control and monitoring devices. The autonomous placement device embodiments described in the present disclosure may be arranged to perform acts associated with smart lighting controllers, telecommunications equipment, public safety equipment, public services equipment, and nearly any other controller or monitor that would otherwise be performed with a human worker in a bucket truck.

In at least some cases, the autonomous placement device embodiments described in the present disclosure are arranged as a payload deployed with an unmanned vehicle (e.g., unmanned aerial vehicle (UAV), drone, robot and the like). In other cases, the autonomous placement device embodiments have a transport means (e.g., wheels, tracks, propellers, clamps, straps, spikes, articulated or otherwise mechanical arms (or legs, or fingers, or the like), adhesives, an engine, a motor, a guidance system, a tracking system, and the like) that is arranged to self-position the autonomous placement device at the location of interest (e.g., atop a streetlight luminaire, a light-post, in a utility vault, or the like). In still other cases autonomous placement devices described in the present disclosure are arranged as a payload having a transport means that is deployed by a UAV.

In a first embodiment, a system, comprises: an autonomous placement device. The autonomous placement device includes a remove-and-place system. The remove-and-place system is arranged to: a) temporarily bind itself to a first lighting control device and rotationally disengage the first lighting control device from a standardized receptacle of an aerial lighting fixture, wherein the standardized receptacle is compliant with a roadway area lighting standard promoted by a standards body; and b) temporarily bind itself to a second lighting control device and rotationally engage the second lighting control device into the standardized receptacle of the aerial lighting fixture. The autonomous placement device also includes a repository having a plurality of storage bays. A first one of the storage bays is arranged to store the first lighting control device after the first lighting control device is removed from the standardized receptacle. A second one of the storage bays is arranged to store the second lighting control device prior to the second lighting control device being deployed into the standardized receptacle. The system further includes an unmanned aerial vehicle (UAV) that is separate and distinct from the autonomous placement device, and a UAV-to-payload coupling system arranged to mechanically couple the autonomous placement device to the UAV.

In some cases of the first embodiment, the standardized receptacle is compliant with an ANSI C136.41 roadway area lighting standard. In some cases, the first one of the storage bays is a different storage bay of the plurality of storage bays from the second one of the storage bays. Sometimes, the remove-and-place system is further arranged to release the second lighting control device into the second one of the storage bays of the repository. And sometimes, the remove-and-place system arranged to retrieve the first lighting control device from the first one of the storage bays of the repository.

The UAV-to-payload coupling system of the first embodiment is integrated with the UAV in some cases. In other cases, however, the UAV-to-payload coupling system is integrated with the autonomous placement device. In some cases, the autonomous placement device further includes a propulsion system arranged to propel the autonomous placement device.

The remove-and-place system of the first embodiment sometimes includes at least one clamping structure arranged to clamp the first and second lighting control devices. In these or other cases, the autonomous placement device includes a processor and a memory. The processor is arranged to execute software instructions stored in the memory to locate the first lighting control device, direct the remove-and-place system to disengage first lighting control device, and temporarily store the first lighting control device in the first storage bay of the repository. Sometimes, the processor is further arranged to execute software instructions stored in the memory to retrieve the second lighting control device from the second storage bay of the repository; and direct the remove-and-place system to engage the second lighting control device into the standardized receptacle.

In a second embodiment, an autonomous placement device, includes a repository arranged to store a plurality of control or monitoring devices, a guidance system arranged to locate a placement position on a utility pole for a first control or monitoring device of the plurality of control or monitoring devices and a remove-and-place system that is arranged to temporarily bind itself to the first control or monitoring device, affix the first control or monitoring device at the placement position, and detach itself from the first control or monitoring device.

In some cases of the second embodiment, the autonomous placement device further includes a housing and a coupling system arranged to mechanically couple the housing of the autonomous placement device to an unmanned vehicle. The unmanned vehicle is arranged to position the autonomous placement device in proximity to the placement position on the utility pole.

In some cases of the second embodiment, the unmanned vehicle is an unmanned aerial vehicle (UAV). In these or other cases, each control or monitoring device of the plurality of control or monitoring devices is a small cell, a distribution transformer monitor, a tilt sensor, or an environmental sensor. Sometimes, each control or monitoring device of the plurality of control or monitoring devices includes at least one clamp. In these or other cases, the autonomous placement device further includes an onboard propulsion system, a surveillance system configured to collect data in an area around the utility pole, an artificial intelligence engine to identify the placement position, and a guidance system to direct the onboard propulsion system to position the remove-and-place system proximate the placement position.

A third embodiment is directed toward a method of placing a control or monitoring device. The method includes: loading a repository of an autonomous placement device with at least one control or monitoring device, configuring a remove-and-place system to temporarily bind itself to the at least one control or monitoring device, coupling the autonomous placement device to an unmanned vehicle, directing the unmanned vehicle to transport the autonomous placement device to a position proximate a streetlight luminaire, and directing the autonomous placement device to rotationally deploy the at least one control or monitoring device into a standardized receptacle of the streetlight luminaire, wherein the standardized receptacle is compliant with a roadway area lighting standard promoted by a standards body.

In some cases of the third embodiment, the method also includes surveilling the area around the streetlight luminaire prior to directing the unmanned vehicle to transport the autonomous placement device to the position proximate the streetlight luminaire and establishing at least one fiducial marker to guide at least one of the transport of the autonomous placement device and the directing of the autonomous placement device. In these or other cases, the method also includes configuring the remove-and-place system to temporarily bind itself to a second control or monitoring device that will be removed from the streetlight luminaire, configuring the repository to store the second control or monitoring device, directing the autonomous placement device to rotationally remove the second control or monitoring device from the streetlight luminaire, and directing the remove-and-place system to load the second control or monitoring device removed from the streetlight luminaire into the repository.

In an alternative embodiment, a system includes a UAV, a payload coupling system, and an autonomous placement device mechanically coupled to the UAV by the payload coupling system. The payload coupling system may be independent or integrated with one of the UAV and the autonomous placement device. According to this embodiment, the autonomous placement device includes a repository arranged to store at least one electronic device and a remove-and-place system operable to retrieve an electronic device from the repository and, after the autonomous placement device has been positioned aerially by the UAV, secure the electronic device to an object at an aerial placement position. The object may be a utility pole or a part thereof, such as a streetlight arm or luminaire, a distribution transformer, or any other object positioned at least 10 feet (at least three meters) off the ground. The electronic device may be a lighting control device, a small cell, a distribution transformer monitor, a tilt sensor, an environmental sensor, or any other aerially-mountable electronic device.

According to another embodiment, the autonomous placement device's remove-and-place system may be further operable, after the autonomous placement device has been positioned aerially by the UAV, to fasten to a second electronic device that is secured to the object or a second object and disengage the second electronic device from the object or the second object. After disengagement, the remove-and-place system may store the second electronic device in the autonomous placement device's repository (e.g., in a storage bay, where the repository includes storage bays). According to this embodiment, the remove-and-place system is used to remove an already installed electronic device permanently, for repair, or for replacement.

According to another embodiment where the aerial placement position is atop a streetlight luminaire, the autonomous placement device's remove-and-place system may be further operable to rotationally engage a connector of the electronic device into a socket located atop the streetlight luminaire to secure the electronic device to the object. In this case, the object may be the streetlight luminaire, which may form part of a utility pole. Where the socket requires pressure to be applied to the electronic device to permit engagement, the remove-and-place system may be further operable to apply a controlled force to the electronic device in a direction toward the socket while rotationally engaging the connector of the electronic device into the socket.

According to another embodiment in which the object is a streetlight luminaire of a utility pole, the autonomous placement device's remove-and-place system is further operable, after the autonomous placement device has been positioned aerially by the UAV, to fasten to a second electronic device having a connector that is rotationally engaged in a socket located atop the streetlight luminaire and rotationally disengage the connector of the second electronic device from the socket. According to this embodiment, the remove-and-place system is used to remove an already installed electronic device from the streetlight luminaire's socket permanently, for repair, or for replacement.

According to a further embodiment, the autonomous placement device may also include a memory and a processor operable to execute software instructions stored in the memory. According to this embodiment, the software instructions may control the operation of the autonomous placement device, including its remove-and-place system. For example, the software may cause the processor to direct the remove-and-place system to locate the aerial placement position, retrieve the electronic device from the repository, and secure the electronic device to the object at the aerial placement position.

According to a further embodiment, the autonomous placement device may also include one or more of a guidance system, a propulsion system, and at least one clamping structure. Where the autonomous placement device includes a guidance system, the guidance system may be operable to locate the aerial placement position prior to securing of the electronic device to the object by the autonomous placement device's remove-and-place system. Where the autonomous placement device includes a propulsion system, the propulsion system may be arranged to position the autonomous placement device's remove-and-place system proximate the aerial placement position. Where the autonomous placement device includes at least one clamping structure, the clamping structure(s) may be arranged to clamp the electronic device at least during retrieval from the autonomous placement device's repository.

According to yet another embodiment, an autonomous placement device includes a repository arranged to store at least one electronic device, a guidance system operable to locate an aerial placement position, and a remove-and-place system operable to retrieve an electronic device from the repository, secure the electronic device to an object at the aerial placement position, and release the electronic device after the electronic device is secured to the object. The autonomous placement device may also include a housing and a coupling system arranged to mechanically couple the housing to an unmanned vehicle.

According to another embodiment, the autonomous placement device's guidance system may include a surveillance engine configured to collect data in an area around the object and an artificial intelligence engine to identify the aerial placement position from the data collected by the surveillance engine. In such an embodiment, the autonomous placement device may further include a propulsion system responsive to the guidance system and operable to position the autonomous placement device's remove-and-place system proximate the aerial placement position.

According to another embodiment where the aerial placement position is atop a streetlight luminaire, the autonomous placement device's remove-and-place system may be further operable to apply a controlled force to the electronic device in a direction toward a socket located atop the streetlight luminaire and rotationally engage a connector of the electronic device into the socket to secure the electronic device to the object.

According to a further embodiment of the present disclosure, a method for securing an electronic device to an object at an aerial placement position includes loading a repository of an autonomous placement device with the electronic device, coupling the autonomous placement device to an unmanned vehicle, remotely controlling the unmanned vehicle to transport the autonomous placement device to the aerial placement position, and directing the autonomous placement device to retrieve the electronic device from the repository and secure the electronic device to the object.

According to an alternative embodiment of such a method, the method may also include surveilling the area around the object prior to remotely controlling the unmanned vehicle to transport the autonomous placement device to the aerial placement position and establishing at least one fiducial marker to guide at least one of the transport of the autonomous placement device to the aerial placement position and the directing of the autonomous placement device to secure the electronic device to the object.

According to another alternative embodiment of such a method, the method may also include removing, by the autonomous placement device, a second electronic device from the object and storing, by the autonomous placement device, the second electronic device in the autonomous placement device's repository after removal from the object.

This Brief Summary has been provided to describe certain concepts in a simplified form that are further described in more detail in the Detailed Description. The Brief Summary does not limit the scope of the claimed subject matter, but rather the words of the claims themselves determine the scope of the claimed subject matter.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a conventional installation or maintenance operation performed on a utility pole.

FIG. 2 is an installation or maintenance operation performed on a utility pole according to the present disclosure.

FIG. 3 is an autonomous placement device embodiment positioned to remove, place, or remove and replace a control or monitoring device from a utility pole.

FIG. 4 is a system to remove, place, or remove and replace a control or monitoring device.

FIGS. 5A-5L are embodiments of control or monitoring devices that may be removed, placed, or removed and replaced by an autonomous placement device.

FIG. 6A is a data flow embodiment to place a control or monitoring device.

FIG. 6B is a data flow embodiment to remove a control or monitoring device.

FIG. 6C is a data flow embodiment to replace/maintain a control or monitoring device.

FIG. 6D is a data flow embodiment to maintain a clamped control or monitoring device.

FIG. 7 is a system level deployment of a portion of an electric grid having various control or monitoring device embodiments coupled to corresponding structures of the electric power grid.

FIG. 8A is a first embodiment of an unmanned vehicle (UV).

FIG. 8B is a second embodiment of the unmanned vehicle (UV).

FIG. 8C-8E are another embodiment of an autonomous placement device.

FIG. 8F is yet one more embodiment of an autonomous placement device.

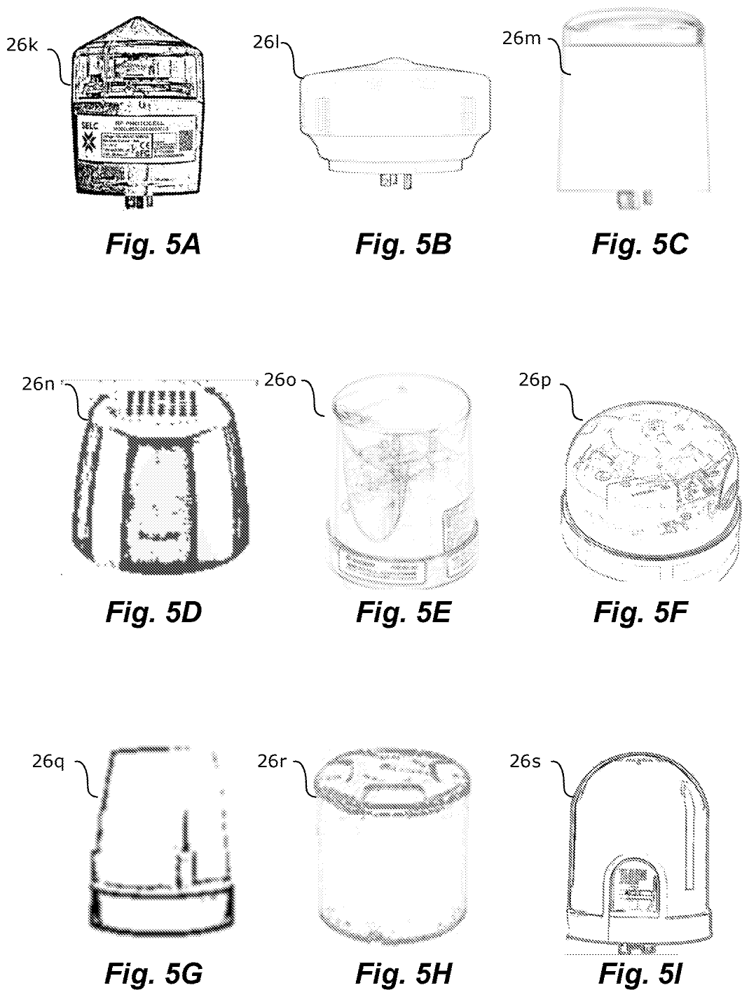

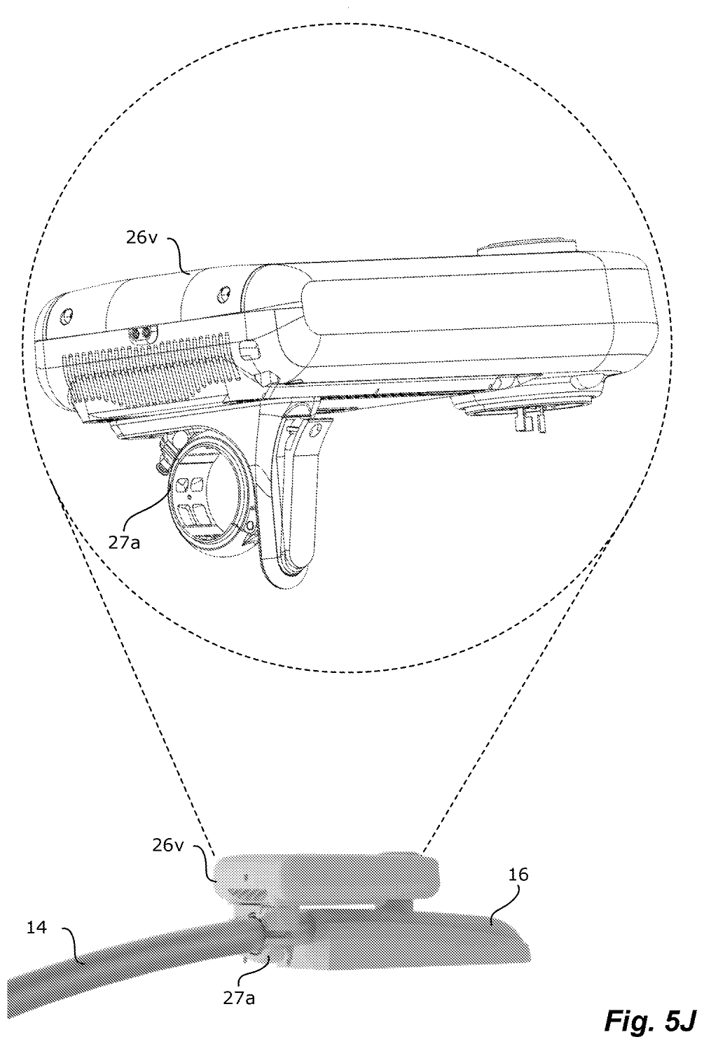

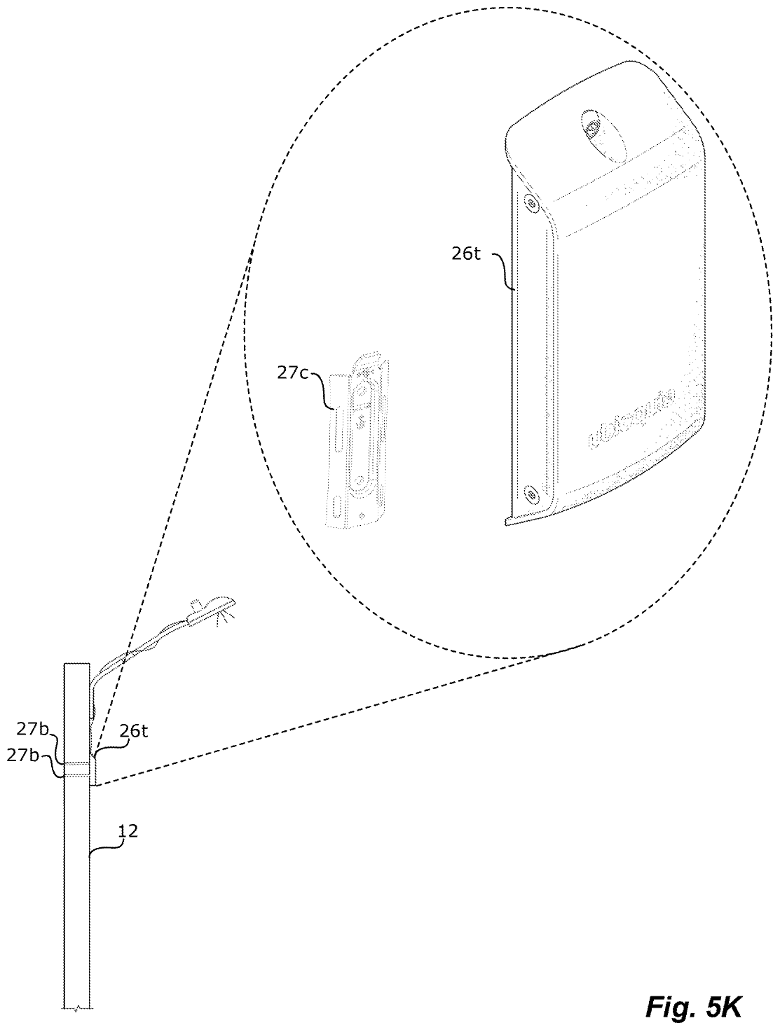

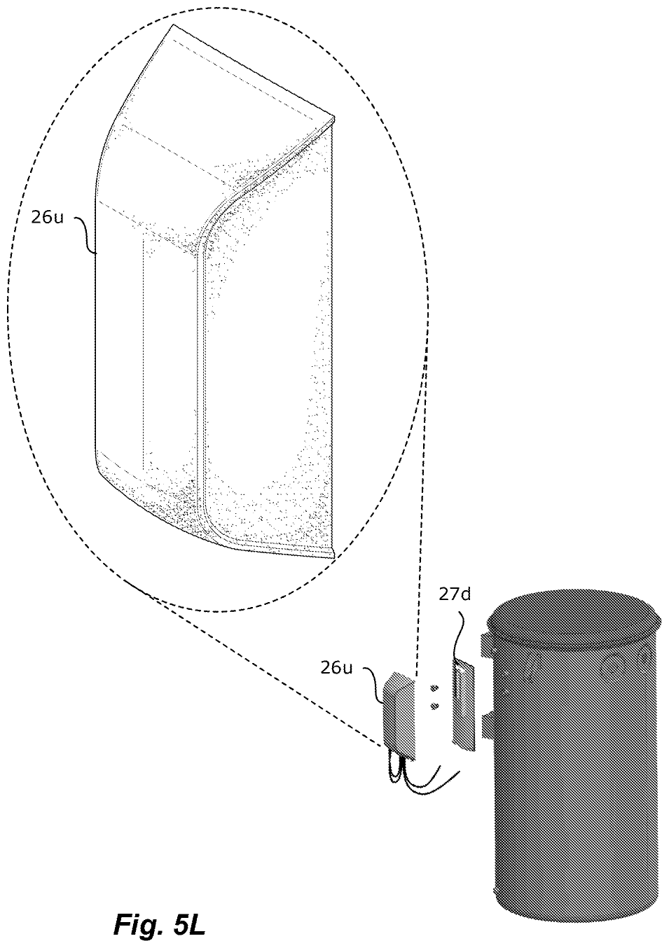

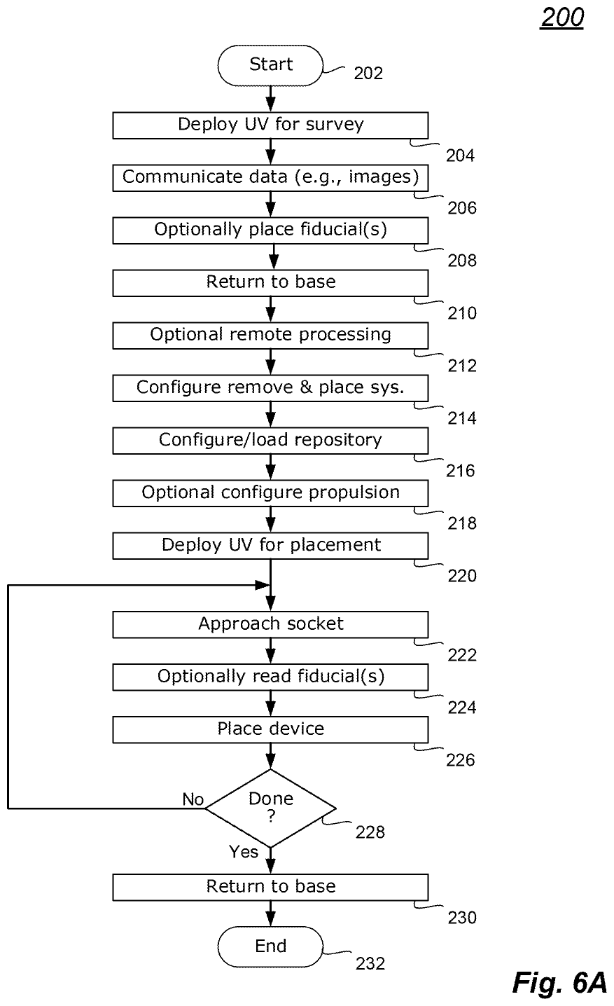

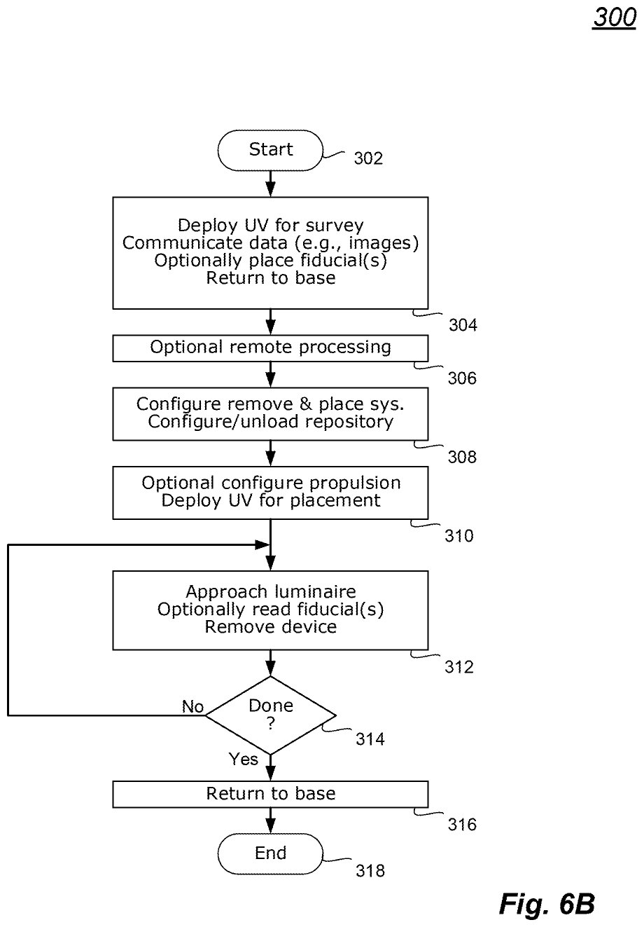

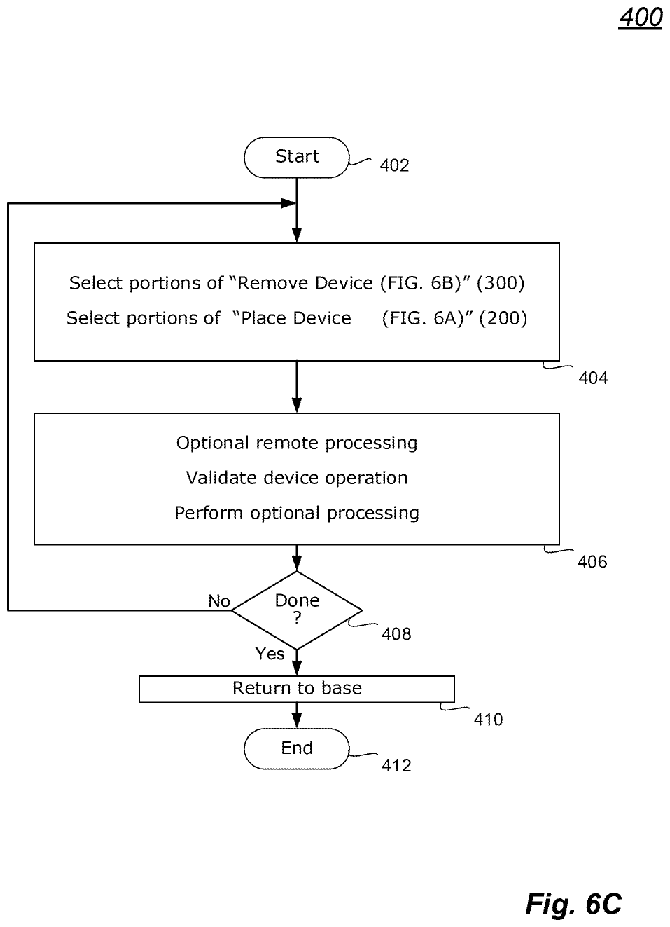

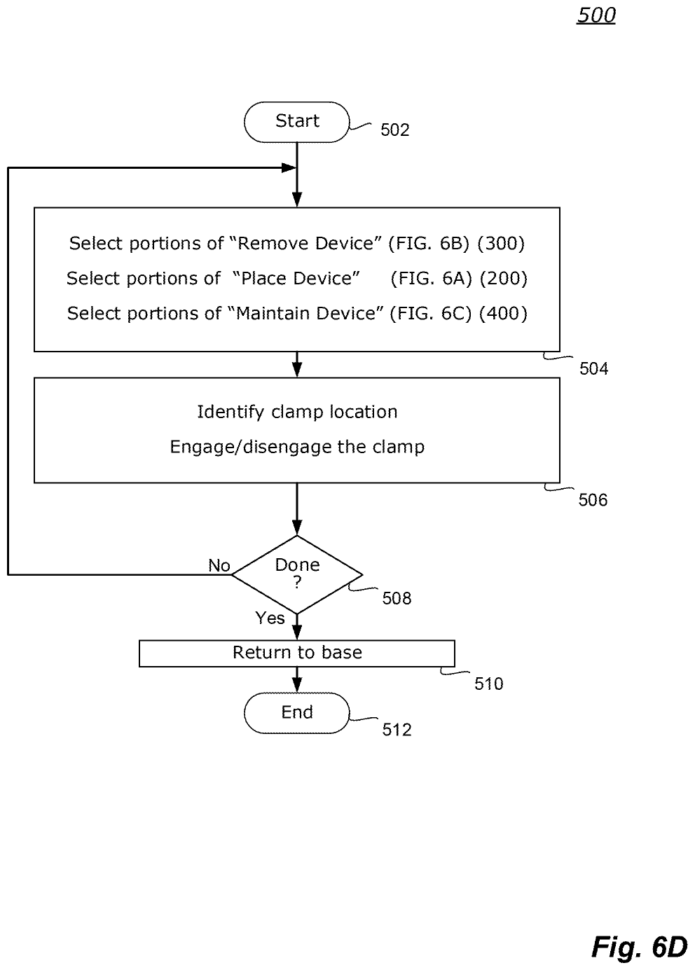

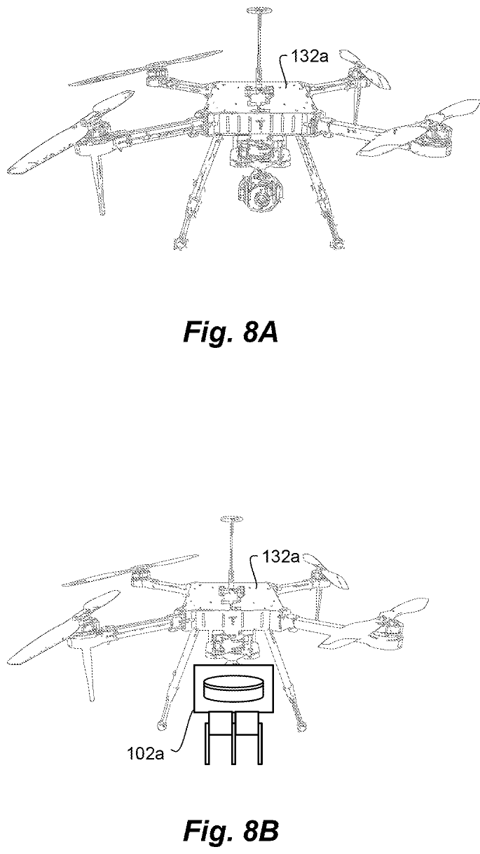

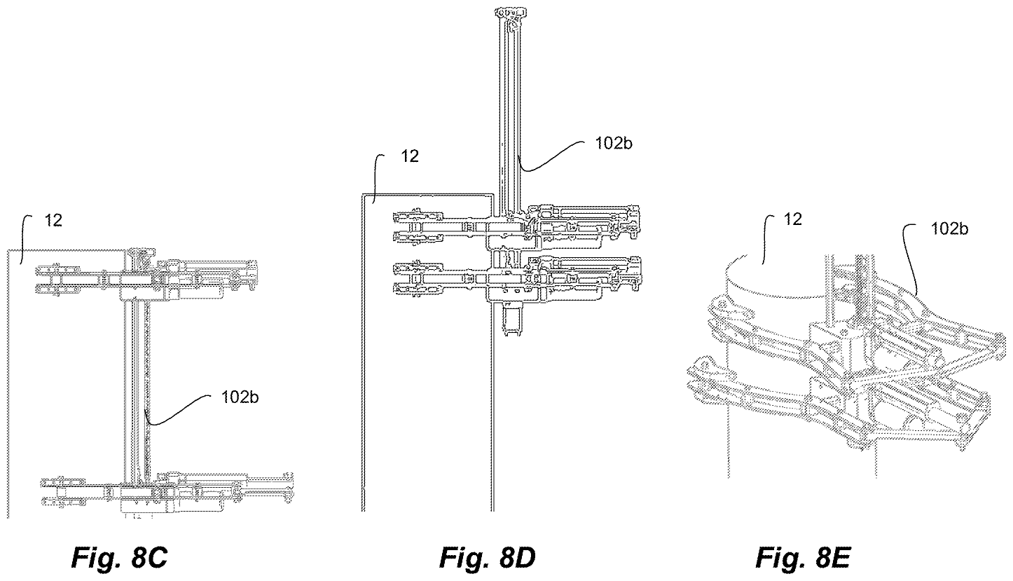

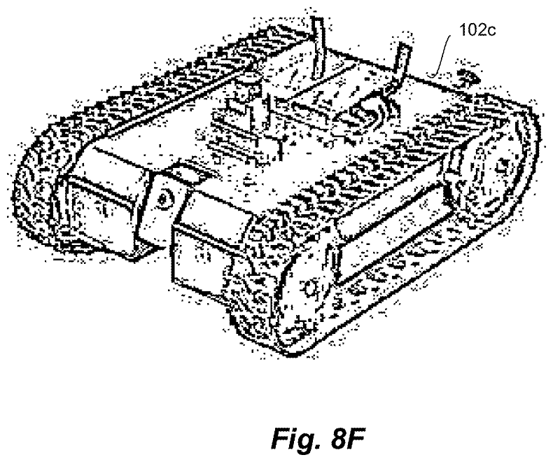

In the present disclosure, for brevity, certain sets of related figures may be referred to as a single, multi-part figure to facilitate a clearer understanding of the illustrated subject matter. For example, FIGS. 5A-5L may be individually or collectively referred to as FIG. 5. FIGS. 6A-6D may be individually or collectively referred to as FIG. 6. And FIGS. 8A-8F may be individually or collectively referred to as FIG. 8. Structures earlier identified are not repeated for brevity.

### DETAILED DESCRIPTION

The present disclosure may be understood more readily by reference to this detailed description and the accompanying figures. The terminology used herein is for the purpose of describing specific embodiments only and is not limiting to the claims unless a court or accepted body of competent jurisdiction determines that such terminology is limiting. Unless specifically defined in the present disclosure, the terminology used herein is to be given its traditional meaning as known in the relevant art.

The device, method, and system embodiments described in this disclosure (i.e., the teachings of this disclosure) enable autonomous placement of a device on a utility pole. The device is a control or monitoring device mechanically or electromechanically coupled to a streetlight or some other part of a utility pole or utility grid infrastructure (e.g., a vault, a light mounted to a building or other structure, a high-tension powerline tower, or the like).

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks have not been shown or described in detail to avoid unnecessarily obscuring more detailed descriptions of the embodiments.

Also in the following description, the autonomous placement device embodiments are arranged to perform acts with respect to certain control or monitoring devices. In many cases, the acts and the control or monitoring devices are described with respect to a utility pole. In system level deployment, for example, a plurality of utility poles are arranged in one or more determined geographic areas. Embodiments of such utility poles may be formed substantially of wood, galvanized steel, aluminum, or some other element or combination of elements. The utility poles may be installed on a foundation of concrete or another foundational material. Various vertical and other support means of the utility poles may be fixedly attached, in part, to the ground or sunk into the earth below the ground

The utility poles described herein may include a streetlight, which has at least one light source positioned in a luminaire fixture. As a point of reference, the luminaire fixtures are typically at least twenty feet above ground level and in at least some cases, the fixtures are between about 20 feet and 40 feet above ground level. In other cases, the streetlight luminaire fixtures may of course be lower than 20 feet above the ground or higher than 40 feet above the ground. In some system level deployments according to the present disclosure, there may be 1,000 or more power poles arranged in one or more determined geographic areas.

Ones of skill in the art will recognize, however, that in addition to a conventional utility pole, the teaching of the present disclosure may be suitably applied to other like structures without straying from the teaching herein. For example, although described as being above the ground on a utility pole, the various controller and monitor embodiments shown and contemplated in the present disclosure may also be deployed at ground level, in a vault that is below-ground-level (i.e., subterranean), in or otherwise attached to a street-level vault, on a high-power pole (e.g., a tower), on a wind power generation tower, on a sign pole, on an antenna, on a flag pole, on a mast, or proximate to some other kind of structure arranged that will host a control or monitoring device. Other embodiments of structures on which the control or monitoring devices discussed in the present disclosure are mounted are of course contemplated.

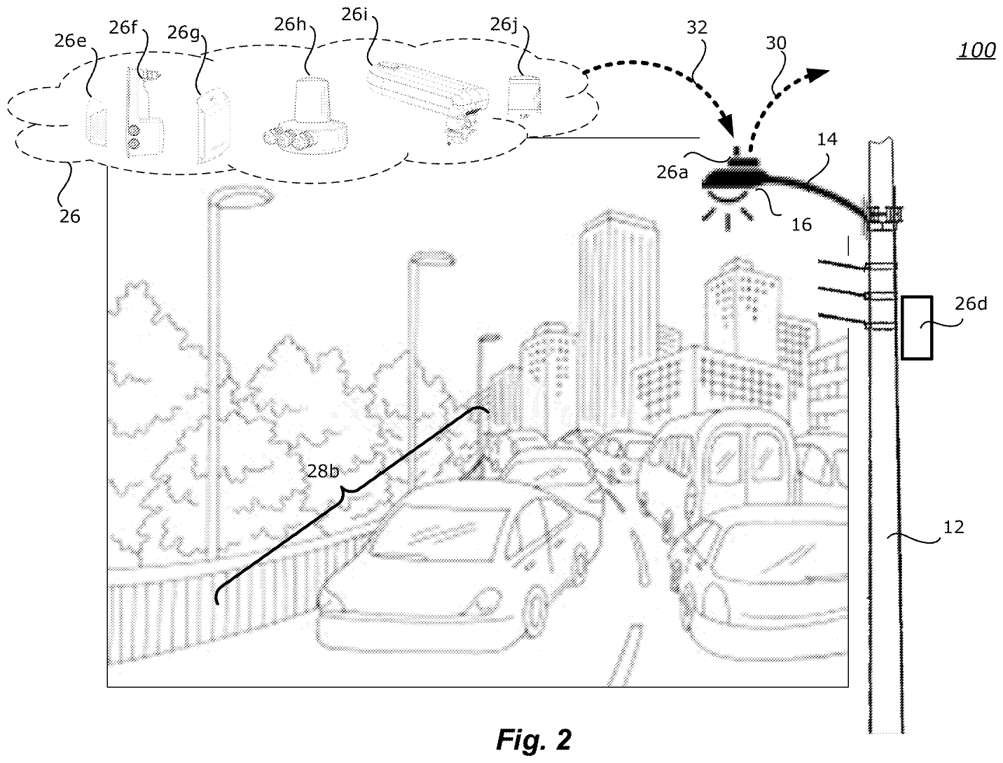

FIG. 2 is an installation or maintenance operation 100 performed on a utility pole 12 according to the present disclosure. A support arm 14 is coupled at its proximal end to the utility pole 12, and a streetlight luminaire 16 is coupled to the distal end of the support arm 14. The first control or monitoring device 26a is electromagnetically coupled to the streetlight luminaire 16, and fourth control or monitoring device is coupled to the utility pole 12 at a selected location.

In the installation or maintenance operation 100 of FIG. 2, the first control or monitoring device 26a will be removed 30 from the streetlight luminaire 16. Also, in the installation or maintenance operation 100 of FIG. 2, another control or monitoring device 26 will be placed in the control or monitoring device 26. One of skill in the art will recognize that the control or monitoring devices 26 include, for example, at least one of a tilt sensor 26e, a distribution transformer monitor 26f, an air quality sensor 26g, a small cell 26h, a smart hub device 26i, and a smart lighting control 26j. Other smart control or monitor devices are also contemplated, and any such device may be maintained at a streetlight luminaire 16, at a support arm 14, or at any suitable portion of a utility pole 12.

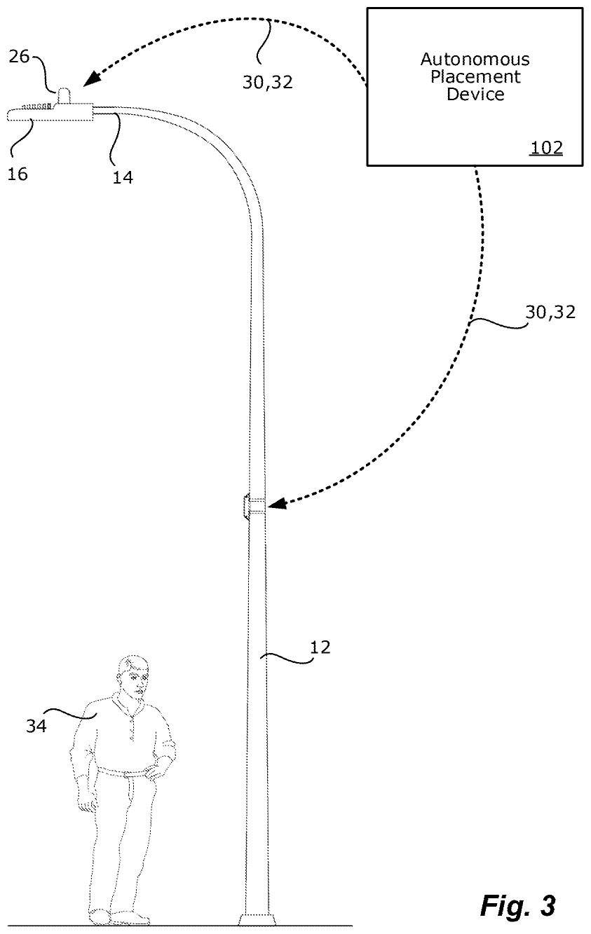

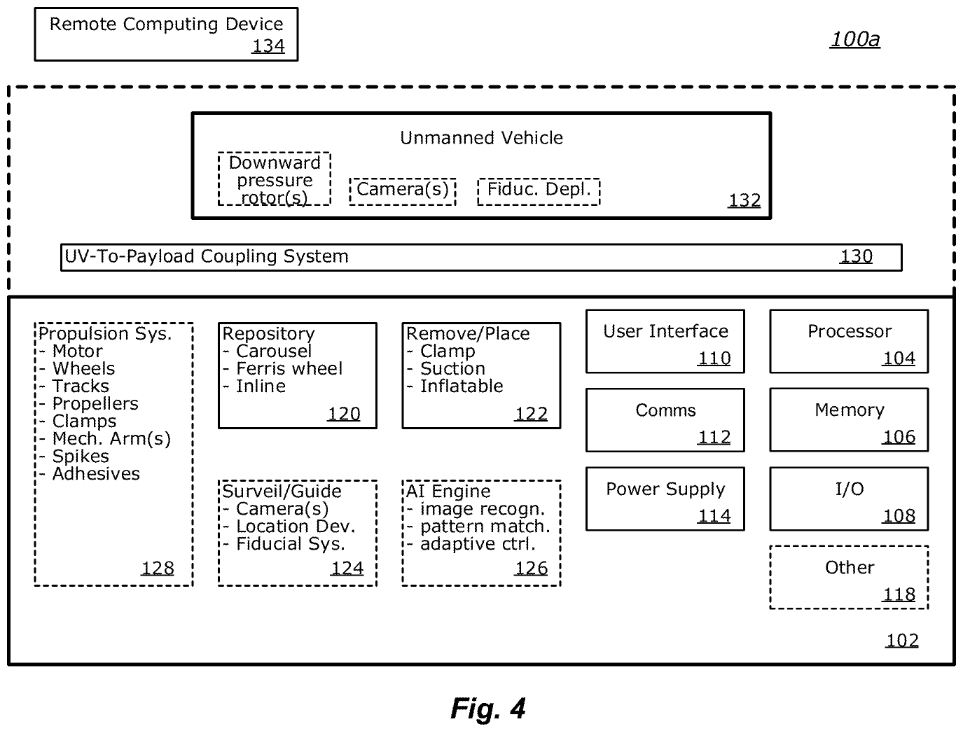

The acts (e.g., removal, placement, replacement, maintenance, testing, updating software, interrogating, verifying, validating, resetting, provisioning, and the like) performed with respect to a control or monitoring device 26 are performed by an autonomous placement device 102 (FIGS. 3-4). In this embodiment, one or more of the acts are performed without permits, without closing roadways, without deploying bucket trucks, and without many other inefficiencies of the conventional operations. During the operation traffic 28b is flowing.

FIG. 3 is an autonomous placement device 102 embodiment positioned to remove 30, place 32, or remove and replace 30, 32 a control or monitoring device 26 from a utility pole 12. A user 34 is standing aside the utility pole 12. In some cases, the autonomous placement device 102 is integrated with an unmanned vehicle such as an unmanned aerial vehicle (e.g., UAV, drone, or the like), an unmanned wheeled vehicle, an unmanned vehicle with tracks, a robot, or the like.

Prior to deployment, the autonomous placement device 102 may be configured programmatically, physically, or in other ways. Optionally, when a control or monitoring device 26 will be removed or placed in a location that is not easily visually accessible, such as atop a streetlight luminaire 16 for example, the location of interest may be first surveyed. For example, considering the removal or placement of a device atop a streetlight, a UAV having at least one camera is deployed to capture image data from above the streetlight. The image data may be used to determine what type of device is currently located in a socket on the streetlight luminaire. The image data may be used to determine an alignment of socket apertures. The image data may be used to determine if unexpected or otherwise anomalous conditions are present atop the streetlight. The image data may of course be used in other ways. In at least some cases, the image data is processed through a machine vision, machine learning, or other artificial intelligence engine.

In some cases where a location is first surveyed before a control or monitoring device is removed or placed, one or more fiducial markers (e.g., magnetic devices, RFID devices, adhesive-backed devices, beacons, or the like) may be placed about the location of interest. A UAV, for example, may capture image data during deployment of one or more fiducial markers. Later, when the control or monitoring device 26 is removed or placed, the fight do show marker is used to locationally assist the autonomous placement device 102. In such cases, guidance, motion, or other acts of the autonomous placement device 102 may be performed using location data generated, calculated, or otherwise determined via the fiducial marker as a reference.

After one or more optional survey acts, a repository in the autonomous placement device 102 may be loaded with one or more control or monitoring devices 26. In some cases, the electromechanical structures in the repository may be adapted to physically interact with the type of device that will be removed or placed in the area of interest. After the repository is configured, the autonomous placement device 102 is deployed.

FIG. 4 is a system 100a to remove, place, or remove and replace a control or monitoring device 26. The system is used to perform certain maintenance via an autonomous placement device 102 embodiment. The autonomous placement device 102 includes a processor 104, memory 106, input/output (I/O) circuitry 108, user interface circuitry 110, communications circuitry 112, and a power supply 114. Optionally, the autonomous placement device 102 includes other circuitry 118 to facilitate various control functions.

The structures of the autonomous placement device 102 may be contained in a housing. The housing may be a single housing, or a multi-part housing. The housing may be formed of plastic, metal, or any suitable material or combination of materials. The housing includes the structure or structures that join the subcomponents of the autonomous placement device 102 together. Accordingly, in at least some cases, when an autonomous placement device 102 is coupled to an unmanned vehicle 132, it is the housing of the autonomous placement device 102 that is coupled to the unmanned vehicle 132.

The processor 104 and memory 106 are communicatively coupled to each other. The memory 106 is arranged to store software instructions that, when executed by the processor, control operations of the autonomous placement device 102 and any one or more of its subsystems. In some cases, the software instructions further control operations of the unmanned vehicle 132. The operations may include any one or more of locating a control or monitoring device 26, directing the remove-and-place system to engage and disengage a control or monitoring device 26, place or remove a control or monitoring device 26 from a standardized socket, retrieve a control or monitoring device 26 from the repository, temporarily store a control or monitoring device 26 in a storage bay of the repository, and perform many other functions.

The I/O circuitry 108 may include any one or more of serial communications ports, digital interfaces, solenoids, relays, voltage sources, headers, solder points, and the like.

The user interface (U/I) module 110 may include any one or more of serial communications ports, keyboards, keyboard inputs, a display, a display interface, buttons, switches, clamps, clasps, potentiometers, variable inductors, touch pads, and the like.

The communications circuitry 112 may include one or more cellular transceivers, modems, serial interfaces, optical interfaces, audio interfaces, and the like. In some cases, an autonomous placement device 102 is arranged to receive over-the-air (OTA) software updates facilitated by information passed through the communications circuitry.

The power supply 114 may include at least one battery or an energy storage device having some other configuration. The power supply 114 in at least some cases includes sufficient storage capacity to drive the electronic circuitry of the autonomous placement device 102 and to also drive a propulsion system.

The autonomous placement device 102 includes a repository 120 and a remove-and-place system 122. Optionally, the autonomous placement device 102 may also include a surveillance/guidance engine 124, and artificial intelligence (AI) engine 126, and a propulsion system 128.

The repository 120 of an autonomous placement device 102 may take any suitable configuration. For example, a repository 120 may include a carousel, a Ferris wheel structure, an inline structure, or some other suitable system of storage for one or more control or monitoring devices 26. The repository includes one or a plurality of storage bays configured to temporarily store at least one control or monitoring device 26. Each storage bay may be open or closed. A storage bay may simply consist in some cases of the location where a clamp or other binding structure temporarily stores a control or monitoring device 26. Accordingly, in some cases, a storage bay is a physical compartment, and in other cases, a storage bay is a location in the autonomous placement device 102 where at least one control or monitoring device 26 is temporarily stored. In at least one case, a repository has a plurality of storage bays configured such that a first one of the storage bays is arranged to store a first control or monitoring device 26 after the first control or monitoring device 26 is removed from a standardized receptacle, and wherein a second one of the storage bays is arranged to store a second control or monitoring device 26 prior to the second control or monitoring device 26 being deployed into the standardized receptacle.

The remove-and-place system 122 may optionally include any one or more of clamps, suction devices, inflatable bladder devices, and the like. The remove-and-place system 122 includes any suitable structure to temporarily bind itself to a control or monitoring device 26 of any configuration. The remove-and-place system 122 may be configured to rotationally engage, disengage, or engage and disengage a control or monitoring device 26 of any configuration to or from a standardized receptacle of an aerial lighting fixture, wherein the standardized receptacle is compliant with a roadway area lighting standard promoted by a standards body (e.g., ANSI C136.41). For example, in some cases, the remove-and-place system 122 is expressly arranged to temporarily bind itself to a control or monitoring device configured as a smart lighting control device. The smart lighting control device may or may not have defined contact points, bosses, apertures, or the like to facilitate the temporary binding operations.

Optionally, the remove-and-place system 122 is configured to rotationally engage/disengage a control or monitoring device 26 from a standardized socket. Optionally, the remove-and-place system 122 is further or alternatively configured to bind (e.g., steel strapping, screws, nails, an adhesive, or some other binding means) a mounting bracket to a vertical portion of a utility pole 12 or distribution transformer, and subsequently, the remove-and-place system 122 is also configured to secure a certain control or monitoring device 26 (e.g., tilt sensor, air quality sensor, environmental sensor, distribution transformer monitor, or the like) to the mounting bracket. Optionally further still, the remove-and-place system 122 is configured to place a clamp of the control or monitoring device 26 about a support arm 14 and tighten the clamp. The subsystems to perform acts that capture, bind, move, rotate, advance, retreat, turn, dispense, release and the like are customized to the particular control or monitoring devices 26 that will be placed or removed. Along these lines, the remove-and-place system 122 works cooperatively with the repository to temporarily bind itself to the control or monitoring device 26 and release itself from the control or monitoring device 26, and such actions are performed to remove a control or monitoring device 26 from the repository, place a control or monitoring device 26 into the repository, or remove and/or place a control or monitoring device 26 at the desired location.

An optional surveillance/guidance engine 124 is arranged to locate a placement position on a utility pole 12 for a control or monitoring device 26. The placement position may be the top of a streetlight luminaire 16 (e.g., an ANSI C136.41 compliant socket, a Zhaga-based standard socket, or the like), a location on a support arm 14, a particular location on the vertical portion of the utility pole 12 (e.g., ten feet above ground level, fifteen feet above ground level, or another height above ground level), a side of a distribution transformer, or some other location.

The surveillance/guidance engine 124 may include camera technologies (e.g., optical, infrared, high-resolution, 360 degree field-of-view), location circuitry (e.g., global positioning system (GPS), global navigation satellite system (GLONASS), BeiDou Navigation Satellite System (BDS), compass, or the like), a fiducial marker system, and other suitable subsystems to assist placement, removal, and replacement of control or monitoring devices 26 by an autonomous placement device 102. A camera technology, for example, may be arranged to capture still or moving image data proximate a position for placement or removal of a control or monitoring device 26. The position may be atop a streetlight luminaire 16, on a wall of a distribution transformer, on a vertical portion of a utility pole 12, or some other location.

The surveillance/guidance engine 124 may include circuitry and other structures to place, identify, and provide guidance information related to fiducial markers. The fiducial markers may be physical fiducial markers placed on or near a placement position of a control or monitoring device 26. In this case, such fiducial markers may include adhesives, magnets, or other adhering means to secure the fiducial marker in place, and the fiducial markers may include optical information (e.g., bar code, color, pattern, or the like), radio frequency (RF) circuitry, or some other structures that provide a signature assurance of the fiducial marker that can be used to guide the autonomous placement device 102 or its substructures into proper placement and alignment for performing maintenance acts on the control or monitoring device 26.

Within the present disclosure, the word “proximate” is used to mean a suitable location near a particular point of interest. The suitable location may be within two feet, within ten feet, within 100 feet, within a city block, or within some other suitable distance as the context requires. For example, a proximate distance to a standardized socket may be close enough to determine an orientation of the sized apertures in the socket. As another example, a proximate distance to a streetlight luminaire may be within 1000 yards such that images captured by the surveillance/guidance engine 124 may be processed by an artificial intelligence engine to ascertain the specific location (e.g., latitude/longitude, street address, or the like) on earth where the streetlight luminaire is located.

The optional artificial intelligence (AI) engine 126, when included, may be used to process images or other data captured by the autonomous placement device 102 or unmanned vehicle 132. The AI engine 126 may include image recognition modules, machine vision modules, pattern matching modules, adaptive control modules, and the like. In at least one case, an AI engine 126 is arranged to receive one or more images of a control or monitoring device 26 placed atop a streetlight luminaire, and from the image data, the AI engine 126 is arranged to determine the manufacturer, model, type, and other such information about the control or monitoring device 26. Such information may be used to configure the repository 120, the remove-and-place system 122, and other components of the autonomous placement device 102. In at least one other case, the AI engine is used by the unmanned vehicle or a self-propelled autonomous placement device 102 to navigate guide wires, powerlines, foot pegs, and other obstacles proximate the location where a control or monitoring device 26 will be placed, removed, or replaced.

When an autonomous placement device 102 includes an optional propulsion system 128, the propulsion system 128 may be used to move the autonomous placement device 102 from a base or starting position into a location where one or more control or monitoring devices 26 will be acted on. Additionally, or alternatively, a propulsion system 128 may be used to precisely locate the autonomous placement device 102 or its subcomponents after the autonomous placement device 102 has been moved by an unmanned vehicle. For example, in at least one case, the autonomous placement device 102 is coupled to an unmanned vehicle 132, and the unmanned vehicle will aerially deliver the autonomous placement device 102 to the top of a streetlight (e.g., on top of the luminaire 16, onto a support arm 14). Next, the autonomous placement device 102 will be decoupled from the unmanned vehicle 132, and the propulsion system 128 will move the autonomous placement device 102 or its subcomponents into a more precise and desirable location. Accordingly, an autonomous placement device 102 that includes a propulsion system 128 may be used with or without an unmanned vehicle 132.

In embodiments contemplated herein, the propulsion system 128 may include any suitable propulsion means. Exemplary propulsion means include motors, wheels, tracks, propellers, rotors, clamps, mechanical arms, spikes, and adhesives. Any other propulsion means may also be used.

In some cases, the autonomous placement device 102 or its supporting components may include a UV-to-payload coupling system 130. The UV-to-payload coupling system 130 is arranged to mechanically or electromechanically couple an autonomous placement device 102 (i.e., a “payload”) to an unmanned vehicle (UV) 132.

In at least some cases, via an electromechanical coupling, the autonomous placement device 102 is arranged to physically join the autonomous placement device 102 to the unmanned vehicle 132 and also arranged to provide power, control information, or power and control information to the unmanned vehicle 132. The communications may be bidirectional. In other cases, the electromechanical coupling may include magnets, solenoids, relays, or the like to physically autonomously and remotely couple and decouple the autonomous placement device 102 to/from the unmanned vehicle 132. In still other cases, the UV-to-payload coupling system 130 is purely a mechanical coupling and not an electrical or communicative coupling.

Optionally, as indicated by dashed lines, the autonomous placement device 102 is fixedly integrated with the unmanned vehicle 132. In at least one of these optional cases, the autonomous placement device 102 structures are permanently integrated with an unmanned aerial vehicle (e.g., a specifically purposed drone). Alternatively, the autonomous placement device 102 is separate and distinct from the unmanned vehicle 132. In such embodiments, the unmanned vehicle may be a commercial off-the-shelf system such as a robot or aerial drone, and the autonomous placement device 102 is a machine designed and constructed for a particular purpose.

In still other cases, the autonomous placement device 102 is detachably coupled to the unmanned vehicle 132. In at least some of these cases, an unmanned vehicle 132 will deliver and release an autonomous placement device 102 at or near a locus where a control or monitoring device 26 will be maintained, once released, the autonomous placement device 102 will perform the desired action with one or more control or monitoring devices 26.

The UV-to-payload coupling system 130 may be integrated with the unmanned vehicle 132. Alternatively, the UV-to-payload coupling system 130 may be integrated with the autonomous placement device 102. In other cases, first portions of a UV-to-payload coupling system 130 are integrated with an unmanned vehicle 132 and second portions of the UV-to-payload coupling system 130 are integrated with the autonomous placement device 102. In still other cases, the UV-to-payload coupling system 130 is a system that is separate and distinct from both the unmanned vehicle 132 and the autonomous placement device 102.

The UV-to-payload coupling system 130 may be formed with clamps, magnets, electromagnets, adhesives, carabiners, hooks, nuts, bolts, threaded rod, hook-and-loop materials, or other suitable coupling means.

The unmanned vehicle 132 may be an unmanned aerial vehicle (e.g., a drone) in some cases. In other cases, the unmanned vehicle 132 may be a robot capable of rolling, walking, climbing, or otherwise moving in one dimension, two dimensions, or three dimensions. In some cases, the unmanned vehicle 132 is controlled by a wired or wireless controller operated by a worker. In other cases, the unmanned vehicle 132 is programmed to operate autonomously. In at least some cases, the unmanned vehicle 132 includes or accesses machine vision or other artificial intelligence engines to navigate obstacles in real time.

In some cases, the unmanned vehicle 132 assists the autonomous placement device 102 in performing its actions. For example, when the unmanned vehicle 132 is an unmanned aerial vehicle, the vehicle may include structures that provide downward pressure, which is often necessary to place or remove a control or monitoring device 26 into or from a standardized socket. Such structures may be arranged as inverted or invertible pitch rotors that permit the UAV to generate a half pound, one pound, five pounds, or more downward force. This downward force, when applied, is sufficient to electromechanically couple or decouple a control or monitoring device 26 to or from a corresponding standardized socket atop a streetlight luminaire 16. In these or other cases, the unmanned vehicle 132 may include adjustable, variable, or changing pitch rotors. These rotors may also be configured to suitably apply clockwise or counterclockwise rotational force. In at least one case, the unmanned vehicle 132 includes inverted fixed rotors that can be deployed specifically to generate a desired downward pressure. In alternative embodiments, the unmanned vehicle 132 includes one or more rotating and counter-rotating motors or structures to generate downward pressure.

In at least one case, the unmanned vehicle 132 or autonomous placement device 102 includes one or more extended or extendable arms arranged to temporarily clamp onto a streetlight luminaire 16. In these cases, the one or more extendible arms may be further optionally arranged to provide a counter-torque when a control or monitoring device 26 is placed or removed in a socket integrated in the streetlight luminaire 26. Optionally, the one or more extendible arms may further still be optionally arranged provide stabilization against downward pressure applied to the control or monitoring device 26 during a placement or removal process.

In at least one case, use of an autonomous placement device 102 includes loading a repository 120 of the autonomous placement device 102 with at least one control or monitoring device 26. The remove-and-place system 122 is configured to temporarily bind itself to the at least one control or monitoring device 26. Next, the autonomous placement device 102 is coupled to an unmanned vehicle 132, and the unmanned vehicle 132 is directed to transport the autonomous placement device 102 to a position proximate a streetlight luminaire 16. The direction may include programming, manual guidance with a control device, or some other direction. Once the unmanned vehicle 132 is proximate the luminaire 16, the autonomous placement device 102 is directed to rotationally deploy one or more control or monitoring devices 26 into corresponding standardized receptacles of the streetlight luminaire 16. In such cases, the standardized receptacle is often compliant with a roadway area lighting standard promoted by a standards body, such as ANSI C136.41, and this standardization enables configuration of the repository 120 and remove-and-place system 122 with appropriate structures to retrieve, bind, and release the control or monitoring devices 26 appropriately. Optionally, using the autonomous placement device 102 may also include surveilling the area around the streetlight luminaire 16 prior to directing the unmanned vehicle 132 to transport the autonomous placement device 102 to the position proximate the streetlight luminaire 16, and establishing at least one fiducial marker to guide at least one of the transport of the autonomous placement device 102 and the directing of the autonomous placement device 102. Also optionally, using the autonomous placement device 102 may include configuring the remove-and-place system 122 to temporarily bind itself to a different control or monitoring device 26 that will be removed from the streetlight luminaire 16, configuring the repository 120 to store the different control or monitoring device 26, directing the autonomous placement device 102 to rotationally remove the different control or monitoring device 26 from the streetlight luminaire 16, and directing the remove-and-place system 122 to load the different control or monitoring device 26 removed from the streetlight luminaire 16 into the repository 120.

The system 100a includes at least one remote computing device 134. The remote computing device 134 is arranged for bidirectional communications with one or more autonomous placement devices 102. The remote computing device 134 is also optionally arranged for bidirectional communications with one or more unmanned vehicles 132. Control information may be communicated from the remote computing device 134. Data collected by the autonomous placement device 102, the unmanned vehicle, or both may be communicated to the remote computing device 134.

FIGS. 5A-5L are embodiments of control or monitoring devices 26 that may be removed, placed, or removed and replaced by an autonomous placement device 102. In the present disclosure, for brevity, any one or more of the control or monitoring devices 26a-26u may be individually or collectively referred to as a control or monitoring device 26.

FIGS. 5A-5I are embodiments of particular smart lighting control devices. For example, FIG. 5A is a smart lighting control embodiment 26k from SMART EFFICIENT LIGHTING CONTROL (SELC). FIG. 5B is a smart lighting control embodiment 26l from CIMCON. FIG. 5C is a smart lighting control embodiment 26m from UBICQUIA. FIG. 5D as a smart lighting control embodiment 26n from SIGNIFY. FIG. 5E is a smart lighting control embodiment 26o from DIMONOFF. FIG. 5F is a smart lighting control embodiment 26p from TELENSA. FIG. 5G is a smart lighting control embodiment 26q from TELEMATICS. FIG. 5H as a smart lighting control embodiment 26r from GENERAL ELECTRIC. FIG. 5I is a smart lighting control embodiment 26s from ACUITY. The smart lighting control embodiments of FIGS. 5A-5I, and other smart lighting control embodiments, conform with one or more roadway lighting standards (e.g., ANSI C136.10, Zhaga Interface Specification Book 2, or the like). Such lighting standards may in some cases specify one or more shapes (e.g., generally cylindrical, cubic, or some other shape), one or more limiting dimensions (e.g., height of a smart lighting controller is between about forty millimeters (40 mm) and 140 mm), or one or more conductive pin structures and patterns, or one or more other characteristics. In such cases, one or more subsystems of an autonomous placement device 102 may be suitably arranged and adaptable for a wide variety of smart lighting controls.

FIG. 5J is a control and monitoring device 26v arranged as a small cell telecommunications device. The small cell telecommunications device is electromechanically coupled to a socket atop a streetlight luminaire 16. The small cell telecommunications device is mechanically coupled to a support arm 14 via a clamp structure 27a. An enlarged view of the small cell telecommunications device is also illustrated in FIG. 5J.

FIG. 5K is a control or monitoring device 26t arranged as an air quality sensor. The air quality sensor is mechanically coupled to a vertical portion of a utility pole 12 via a first clamping structure 27b, which is embodied in FIG. 5J as a pair of steel straps, and a second clamping structure 27c, which is embodied in FIG. 5J as a mounted in bracket. In the control or monitoring device 26t embodiment of FIG. 5J, the air quality sensor device is fixedly bound to the second clamping structure 27c (i.e., mounting bracket), and the mounting bracket is fixedly bound to the utility pole 12 via the first clamping structure 27b (steel straps). An enlarged view of the air quality sensor and its mounting bracket are also illustrated in FIG. 5K. In other embodiments, the control or monitoring device 26t may be a tilt sensor, a water detection sensor, and environmental sensor, or any other such device suitably mounted to a vertical portion of a utility pole 12.

FIG. 5L is a control or monitoring device 26u arranged as a distribution transformer monitor. The distribution transformer monitor is mechanically coupled to a distribution transformer via a clamping structure 27d, which is configured in FIG. 5L as a mounting bracket. The distribution transformer is mounted to a utility pole 12, which pole is not shown in FIG. 5L. And enlarged view of the distribution transformer monitor is also illustrated in FIG. 5L.

The control or monitoring devices of FIGS. 5J-5L may be particularly arranged for coupling to a portion of a utility pole 12, a support arm 14, atop a streetlight luminaire 16, or in some other location on or about the utility pole 12. In these cases, one or more subsystems of an autonomous placement device 102 are specifically formed, configured, and otherwise arranged to perform acts of removal, placement, or removal and replacement of such devices. For example, at least one subsystem may be arranged to identify threaded structures (e.g., nuts, bolts, threaded rods, and the like) and tighten, loosen, or tighten and loosen the relevant structures. One or more other subsystems may be arranged with articulating arms to hold and position specifically formed brackets, straps, control devices, and the like in a desired location, and such subsystems may be further arranged to attach or detach, as the case may be, the particular structure. Still other subsystems may be arranged to store, release, or move the control or monitoring devices 26 in to and out from the repository 120.

FIG. 6A is a data flow “placement embodiment” 200 to place a control or monitoring device 26. In an exemplary case, a control or monitoring device 26 such as a smart lighting controller (e.g., the devices of FIGS. 5A-5I) will be placed in a socket integrated with a top side of a streetlight luminaire 16. The socket is a receiving portion of a connector system that is compliant with a roadway area lighting standard promoted by the standards body (e.g., ANSI C136.41, Zhaga, Book 2, or some other standard). In this placement embodiment 200, the socket is empty, which means there is no control or monitoring device 26, or any other device electromechanically plugged into the socket.

Processing in the placement embodiment begins at 202. At 204, an unmanned vehicle 132 is deployed to optionally conduct a survey. In at least some cases, the deployment of the unmanned vehicle 132, and other acts of the placement embodiment 200, may be performed by a single worker without closing traffic on a street and without the use of a bucket truck or other lift device. In some cases, the unmanned vehicle 132 operates entirely autonomously. That is, the unmanned vehicle 132 departs its starting base, moves proximate the location where the control or monitoring device 26 will be deployed, and conducts its survey acts. In other cases, the unmanned vehicle 132 may be partially or entirely controlled by a worker. In such cases, the worker may steer or otherwise control the operational direction and movement of the unmanned vehicle 132. In these cases, the worker may also direct the operations of the unmanned vehicle 132 around the particular location (e.g., change altitude, change direction, change orientation, hover, rotate, get closer, move back, take pictures, take additional pictures, and the like).

The unmanned vehicle 132 may be configured as a UAV having at least one camera. Alternatively, the unmanned vehicle 132 may be configured as a rolling device, a tethered device, a climbing device, or some other unmanned vehicle. When deployed, the unmanned vehicle 132 will approach the top of the streetlight luminaire 16. The unmanned vehicle 132 may capture one or more images, which may be still images, a stream of images (i.e., video data), infrared data or the like. Processing advances to 206.

At 206, the data captured by the unmanned vehicle 132 is communicated. In some cases, for example, the captured data includes one or more images communicated wirelessly to a remote computing device 134. The remote computing device may be a remote computing server, such as a cloud computing system, at a location many miles (one mile, ten miles, hundreds of miles, thousands of miles) from the current location of the unmanned vehicle 132. Alternatively, or additionally, the remote computing device 134 may include a portable computing device (e.g., smart phone, a tablet, a laptop computer, or the like). In this latter case, an operator of the unmanned vehicle 132 may visually inspect and analyze the top of the streetlight luminaire 16 without a bucket truck, lift, or the like.

In addition to image data, the data communicated at 206 may include data identifying the unmanned vehicle 132, location data (e.g., global positioning system (GPS), latitude/longitude/altitude, or the like), environmental or metrological data (e.g., temperature, humidity, wind direction, wind velocity, and the like), status data (e.g., power level of the unmanned vehicle 132, communications signal strength, and the like), and other data. In some cases, such as in remote locations, wireless cellular communications may not be possible. In these cases, data communication and 206 may include wired or wireless communications to a remote computing device 134 located at ground level in proximity to the utility pole 12, streetlight luminaire 16, or other such location. Such data may then be processed locally at ground level or communicated back to yet another remote computing device 134 using a different communications medium. Processing advances to 208.

At 208, the unmanned vehicle 132 may optionally place a fiducial marker at a location where a control or monitoring device 26 will be deployed. In some cases, for example, the fiducial marker is a magnet, or otherwise includes a magnet. In such cases, the fiducial marker will adhere to a top side surface of a streetlight luminaire 16 comprising at least some ferrous material in its structure. In these or other cases, the fiducial marker may include an adhesive or another means of bonding the marker to the top side surface of the luminaire 16. The fiducial marker may include an optical mark such as a plus side (“+”), a bullseye, a set of boxes or other geometric shapes, or some other optically recognizable mark. In other cases, fiducial marker may include an RFID, beacon, or other electronic mark. Sometimes, the fiducial marker is a virtual fiducial marker electronically or computationally attached or otherwise linked to a particular location represented in the image data. Other fiducial markers are also contemplated.

In some cases, operations at 204-208 are repeated for additional streetlight luminaires 16 or other locations where control or monitoring devices 26 will be deployed. For example, the unmanned vehicle 132 may travel to two or more utility poles that are within a reasonably accessible distance (e.g., with 100 feet, within a city block, within several city blocks, within 1000 yards, within one mile, or within another suitable distance that is within the operational parameters and government regulations for operation of the unmanned vehicle 132). In these cases, the unmanned vehicle 132 may capture additional images, communicate imagery and other information such as location, status and the like, and place optional fiducial markers.

Processing advances to 210. At 210, the unmanned vehicle 132 returns to its starting base or other desired location. Processing advances to 212.

At 212, data captured during the surveillance is processed. The processing may include artificial intelligence (AI) operations. The processing may occur in a remote computing device 134. Additionally, or alternatively, the processing may occur in the autonomous placement device 102. In at least some cases, the AI operations include image recognition operations, pattern matching operations, and the like. For example, images captured during surveillance from a perspective above the streetlight luminaire 16 may be analyzed to determine a model of streetlight luminaire 16, a manufacturer of streetlight luminaire 16, whether the streetlight luminaire or an integrated socket has been damaged or is otherwise unavailable for autonomous placement of a control or monitoring device 26, a type of socket integrated atop the streetlight luminaire 16, a directional orientation of the socket integrated atop the streetlight luminaire 16 (e.g., determination of the “large” aperture in an ANSI C136.41 compliant socket, determination of which aperture in a socket faces closest to North, and the like), and a precise height above ground level of the socket integrated atop the streetlight luminaire 16. Other processing, and particularly AI processing is of course contemplated. Processing advances to 214.

At 214, the remove-and-place system 122 is configured. The remove-and-place system 122 may include clamps, suction devices, inflatable devices, or the like (FIG. 4). In some cases, the remove-and-place system 122 is arranged only to place one or more control or monitoring devices 26, in other cases, the remove-and-place system 122 is arranged only to remove one or more control or monitoring devices 26, and in still other cases, the remove-and-place system 122 is arranged only to both remove and place (i.e., replace) one or more control or monitoring devices 26. Sometimes, the autonomous placement device 102 is arranged to place two or more different control or monitoring devices 26. For this and other reasons, the worker operating the autonomous placement device 102 may configure the device. In some cases, the control or monitoring device 26 is compliant with ANSI C136.10. In this way, particular parameters about the control or monitoring device 26 will be known. For example, the device in such case may range from 80 millimeters to 92 millimeters (80-92 mm) in diameter and from 40 millimeters to 140 millimeters (40 mm-140 mm) in height. The shape and texture of the control or monitoring device 26 will be known, and the remove-and-place system 122 will be configured to temporarily hold the device, apply downward rotational pressure to deploy the device in a compatible socket.

In some cases, the remove-and-place system 122 includes one or more rotational devices such as motors. In these or other cases, the remove-and-place system 122 may rely on, or otherwise take advantage of, rotational force, lift, and downward pressure generated by the unmanned vehicle 132. In at least one case, an unmanned vehicle 132 is arranged as a UAV having inverted or invertible pitch rotors that permit the UAV to generate sufficient downward force to electromechanically couple or decouple a control or monitoring device 26 to or from a corresponding socket atop a streetlight luminaire 16. Such adjustable, variable, or changing pitch rotors may also be configured to suitably apply clockwise or counterclockwise rotational force. In other cases, the UAV includes inverted fixed rotors that are deployed specifically to generate a sufficient downward pressure. Processing advances to 216.

At 216, a repository 120 of the autonomous placement device 102 is configured.

The repository 120 may include a carousel, a Ferris wheel, in in-line temporary storage means, or another suitable repository 120 (FIG. 4). During such configuration one or more control or monitoring devices 26 that will be deployed by the autonomous placement device 122 may be loaded in the repository 120. Processing advances to 218.

At 218 a propulsion system 128 may be optionally configured. In some cases, the autonomous placement device 102 may include one or more motors, wheels, tracks, rollers, propellers, clamps, straps, mechanical arms, spikes, adhesives, magnets, electromagnets and or some other transport means (FIG. 4). Sometimes, the propulsion system is used to move the autonomous placement device on a utility pole 12, support arm 14, streetlight luminaire 16, or some other structure. For example, an unmanned vehicle 132 may be configured as a UAV. The autonomous placement device 102 is coupled to the UAV via the UV-to-payload coupling system 130. The UAV transports the autonomous placement device 102 proximate the location where the control or monitoring device 26 will be deployed. Subsequently, the UAV decouples the autonomous placement device 102, and the autonomous placement device 102 self-propelled itself to the appropriate location, and performs the appropriate acts for removal, placement, or replacement of the control or monitoring device 26.

The UV-to-payload coupling system 130 may include clamps, magnets, electromagnets, solenoids, clips, or other attachable/detachable structures. In this way, the UV-to-payload coupling system 130 may operate without manual intervention. In other cases, the UV-to-payload coupling system 130 may include other structures for permanent or semipermanent coupling of the autonomous placement device 102 two the unmanned vehicle 132 (e.g., nuts, bolts, screws, pins, and other like means). In some cases, the UV-to-payload coupling system 130 provides one or more electrical conduits between the autonomous placement device 102 and the unmanned vehicle 132. The electrical conduits may be used to pass power from the autonomous placement device 102 (e.g., power supply 114) to the unmanned vehicle 132 or vice versa. In some cases, the electrical conduits may be used to pass control information or data between the autonomous placement device 102 and the unmanned vehicle 132.

Configuration of the optional propulsion system 128 may include adjusting arms arranged to affirmatively “grab” a utility pole 12, support arm 14, or streetlight luminaire 16 housing. Such adjustments may include the size of structures that will grab, the amount of pressure that will be applied, a response to particular feedback, and the like. In some cases, where an unmanned vehicle 132 is not included, the propulsion system 128 may be directed to self-propelled itself from a ground level to an appropriate height on a utility pole 12, along a support arm 14, and onto or otherwise about a streetlight luminaire 16. Processing advances to 220.

At 220, the unmanned vehicle 132 has been appropriately coupled to the automatic placement device 102. The automatic placement device 102 has been appropriately configured as described herein. The unmanned vehicle 132 is deployed for placement of one or more control or monitoring devices 26. Processing advances to 222 and 224.

Processing at 224 is optional. When so included, processing at 222 and 224 is cooperative. At 222, the autonomous placement device 102 approaches the location where a control or monitoring device 26 will be deployed. In some cases, the autonomous placement device 102 has self-propelled itself to such location. In other cases, the autonomous placement device 102 has been transported to the location by an unmanned vehicle 132. In at least some cases, one or more fiducial markers have previously been deployed. In such cases, the fiducial markers may be used as a guide.

In one embodiment, for example, the automatic placement device 102 is coupled directly below an unmanned vehicle 132 that is configured as a UAV. In this way, cameras mounted directly below the UAV may not be able to “see” the socket atop the streetlight luminaire 16. Alternatively, cameras previously mounted on the UAV during a surveillance operation may have been removed so that the automatic placement device 102 could be transported. In still other cases, a first unmanned vehicle 132 performs surveillance operations (e.g., using one or more cameras), and a second different unmanned vehicle 132 is coupled to the automatic placement device 102. In any of these cases, a surveillance/guidance engine 124 of the automatic placement device 102 is arranged to make use of the previously deployed one or more fiducial markers to help appropriately identify the correct deployment location.

When fiducial markers have been deployed, they will be processed by the surveillance/guidance engine 124. Cameras, for example, may capture image data that will be used to locate a fiducial marker. An RFID reader may locate a signal produced by fiducial marker. A Bluetooth radio may locate a different signal produced by particular beacon. Processing by the processor 104 executing software instructions from memory 106, which may also include processing by an AI engine 126, for example, will be used, or has been used, to determine an exact location and orientation of an ANSI C136.41 compatible socket. Processing advances to 226.

At 226, a control or monitoring device 26 is deployed. In some cases, the deployment means that the control or monitoring device 26 has first electrical contacts (e.g., pins) suitably aligned with second electrical contacts (e.g., apertures), in the control or monitoring device 26 is electromechanically coupled with the downward and rotational force to a socket integrated with the streetlight luminaire 16. Performance of this placement act is enabled by cooperative operation of the repository 120 and the remove-and-place system 122. The systems may further cooperate with the optional surveillance/guidance system 124 and AI engine 126. In operation, for example, the repository 120 makes the control or monitoring device 26 available for deployment. Such act may involve rotation of a carousel or Ferris wheel, advancement of a linear storage location, or some other action. The control or monitoring device 26 is removably coupled to the remove-and-place system 122. And after such coupling, the control or monitoring device 26 is positioned to make an electromechanical contact with an appropriate socket. The control or monitoring device 26 is then advanced into the socket and rotated. Once rotated, the control or monitoring device 26 self-secured, and the remove-and-place system 122 releases the control or monitoring device 26 from its grip. In some cases, the autonomous placement device 102 retracts all or a portion of the remove-and-place system 122. In other cases, the autonomous placement device 102 withdraws from the deployment location autonomously or via withdrawal by the unmanned vehicle 132. Processing advances to 228.

At 228, if additional control or monitoring devices 26 are to be placed, processing returns to 222. In the alternative, processing advances to 230.

At 230, the autonomous placement device 102 returns, or is returned, or other desired location. Processing ends at 232.

FIG. 6B is a data flow “removal” embodiment 300 to remove a control or monitoring device 26. In an exemplary case, a control or monitoring device 26 such as a smart lighting controller (e.g., the devices of FIGS. 5A-5I) will be removed from a socket integrated with a top side of a streetlight luminaire 16. Processing in the removal embodiment begins at 302. At 304, an unmanned vehicle 132 is optionally deployed to conduct a survey. In at least some cases, the deployment of the unmanned vehicle 132, and other acts of the removal embodiment 300, may be performed by a single worker without closing traffic on a street and without the use of a bucket truck or other lift device. In some cases, the unmanned vehicle 132 operates entirely autonomously. That is, the unmanned vehicle 132 departs its starting base, moves proximate the location where the control or monitoring device 26 will be removed, and conducts its survey acts. In other cases, the unmanned vehicle 132 may be partially or entirely controlled by a worker. In such cases, the worker may steer or otherwise control the operational direction and movement of the unmanned vehicle 132. In these cases, the worker may also direct the operations of the unmanned vehicle 132 around the particular location (e.g., change altitude, change direction, change orientation, hover, rotate, get closer, move back, take pictures, take additional pictures, and the like). The unmanned vehicle 132 may be configured as described in the placement embodiment 200 and configured to capture one or more images, which may be still images, a stream of images (i.e., video data), infrared data or the like.

Data captured by the optionally deployed unmanned vehicle 132 is communicated. The communication may be as described in the placement embodiment 200, specifically 206. In addition, in some cases, the unmanned vehicle will operate according to a pre-programmed flight plan or autonomous data-based flight pattern. Alternatively, a ground-based operator may have or take control of the unmanned vehicle 132. In these cases, the ground-based operator may perform additional actions to ascertain the size, condition, type (e.g., manufacturer, model, serial number, and the like), or other parameters and characteristics of control or monitoring device 26 that will be removed from the luminaire 16.

Along the lines of processing described in the placement embodiment 200, particularly 208, the unmanned vehicle 132 may optionally place one or more fiducial markers at a location where a control or monitoring device 26 will be removed. The acts at 304 may be repeated for any suitable number of utility poles 12 where a control or monitoring device 26 will be removed. As in the removal embodiment 200, particularly 204-210, the unmanned vehicle 132 may return to its point of origin or other base after performing survey operations on one luminaire 16, two luminaires 16, or any suitable number of luminaires 16. Processing advances to 306.

At 306, data captured during the surveillance processed. The processing may include artificial intelligence (AI) operations. The processing may occur in a remote computing device 134. Additionally, or alternatively, the processing may occur in the autonomous placement device 102. In at least some cases, the AI operations include image recognition operations, pattern matching operations, and the like. The AI operations may be as described in the placement embodiment 200, particularly 212. Alternatively, or additionally, the AI operations may include image processing to determine the manufacturer, model, serial number, or other characteristics of the control or monitoring device 26 to be removed. In at least some cases, the AI operations include acts to retrieve data sheets, technical specifications, or other suitable information about the control or monitoring device 26 be removed. Processing advances to 308.

At 308, the remove-and-place system 122 is configured. The remove-and-place system 122 may include clamps, suction devices, inflatable devices, or the like (FIG. 4). In at least some cases, the autonomous placement device 102 is arranged to remove two or more control or monitoring devices 26, which may be of the same type, or which may be of different types. In some cases, the control or monitoring device 26 to be removed is compliant with ANSI C136.10. In this way, known parameters about the monitor or control device 26 may be used to configure the remove-and-place system 122. The remove-and-place system 122 may be arranged as described with respect to the placement embodiment 200, particularly 214. In addition to configuring the remove-and-place system 122, a repository 120 may also be suitably arranged to temporarily store one or more control or monitoring devices 26 as they are removed. The repository 120 may be configured as described in the placement embodiment 200, particularly 216. Alternatively, or additionally, the repository 120 may be configured differently. For example, in at least one case, the mechanism of the remove-and-place system 122 that captures the monitoring and control device 26 to be removed may itself perform the acts of the repository 120. That is, in some cases, a monitoring or control device 26 will be removed from a luminaire 216, and the monitoring or control device 26 will be maintained in the remove-and-place system 122 until the unmanned vehicle 132 returns to its desired destination. Processing advances to 310.

At 310 a propulsion system 128 may be optionally configured. The propulsion system 128 may be configured as described in the placement embodiment 200, particularly 218. At 310, the unmanned vehicle 132 has been appropriately coupled to the automatic placement device 102, and the automatic placement device 102 has been appropriately configured as described herein. The unmanned vehicle 132 is deployed to remove one or more control or monitoring devices 26. Processing advances to 312.

At 312, the unmanned vehicle 132 approaches the luminaire having the control and monitoring device 26 that will be removed. If one or more fiducial markers were placed, the autonomous placement device 102 may use them to approach the location where a control or monitoring device 26 will be removed. The use of the fiducial markers may be along the lines of the placement embodiment 200, particularly 224. In some cases, the autonomous placement device 102 has self-propelled itself to such location. In other cases, the autonomous placement device 102 has been transported to the location by an unmanned vehicle 132.

The autonomous placement device 102 removes the control or monitoring device 26. In some cases, the removal means that control or monitoring device 26 is enveloped, grabbed, locked-on, or otherwise removably attached to the remove-and-place system 122. Next, the autonomous placement device 102 electromechanically decouples the control or monitoring device 26 from the socket with downward and rotational force. Performance of this removal act may be enabled by cooperative operation of the repository 120 and the unmanned vehicle 132. The systems may further cooperate with the optional surveillance/guidance system 124, an optional AI engine 126, or other circuitry 118 and structures of the autonomous placement device 102. The repository 120 receives the control or monitoring device 26 available to receive the removed device. Such act may involve rotation of a carousel or Ferris wheel, advancement of a linear storage location, or some other action. Processing advances to 314.

At 314, if additional control or monitoring devices 26 are to be removed, processing returns to 312. In the alternative, processing advances to 316.

At 316 the autonomous placement device 102 returns, or is returned, to its starting base or other suitable location. Processing ends at 318.

FIG. 6C is a data flow “replace/maintain” embodiment 400 to replace/maintain one or more control or monitoring devices 26. The acts of the replacement embodiment 400 may substantially comprise some or all of the acts of the placement embodiment 200 and the removal embodiment 300. Processing begins at 402.

At 404, one or more acts of the removal embodiment 300 and the placement embodiment 200 are performed. For example, an unmanned vehicle 132 may be deployed, multimedia data (e.g., images, video, audio) may be collected and communicated, one or more fiducial markers may be placed, and other acts may be performed. A remove-and-place system 122 may be configured, a repository 120 may be loaded or unloaded as the case may be, the autonomous placement device 102 may be coupled to the unmanned vehicle 132 and additionally, or alternatively, a propulsion system for the autonomous placement device 102 may be configured. Processing advances to 406.

At 406, the control or monitoring device 26 has been electromechanically coupled to a streetlight luminaire 16 (i.e., once the device has been placed). Optional remote processing may be performed, operation of the device is validated, and additional processing may also be performed. Collectively, the validation, remote processing, and additional processing may be referred to as maintenance.

In some cases, once the control or monitoring device 26 has been placed, a remote computing server 134 (FIG. 4) may be communicatively coupled to the device. The communicative coupling may be direct to the control or monitoring device 26, or alternatively, the communicative coupling may be through the autonomous placement device 102. The communicative coupling may be in real time. In at least one embodiment, communications between the control or monitoring device 26 and the remote computing server 134 is time delayed. In some cases, software, firmware, or data in the control or monitoring device 26 is updated. In these or other cases, information generated or collected by the control or monitoring device 26 is communicated back to the remote computing server 134.

In some cases, initialization data is downloaded to the control or monitoring device 26. The initialization data may include calibration data, a feature set configured to enable/disable certain features on the device in correspondence with features that an end customer is expecting, and the like. Other initialization data is also contemplated.

Software, firmware, or firmware and software may be loaded onto the control or monitoring device 26. In some cases, a control or monitoring device 26 has been previously placed on the luminaire 16, and the only operation performed by the autonomous placement device 102 is to perform a software or firmware update. For example, if a particular control or monitoring device 26 is otherwise inaccessible wirelessly, the autonomous placement device 102 may be configured to approach the device on the luminaire, and perform a wireless (e.g., optical, short range RF, audio, or the like) or physical contact (button press, magnetic- or electromagnetic-based motion of a switch, or the like), to awaken or otherwise re-initialize the device, and in these cases, software or firmware may be optionally updated.

Validation of the control or monitoring device 26 may include capturing a serial number, generating geographic information (e.g., GPS readings, altimeter readings, image capture and AI-based recognition, and the like), performing tests (interactive testing, power on self-test (POST), self-testing, and the like), and the like. In some cases, image data of the control or monitoring device 26 placed in the streetlight luminaire 16 may be captured and communicated to the remote computing server 134. The image data may be viewed by a human to validate proper placement, or in some cases, the image data may be passed through and artificial intelligence (AI) engine for a computationally determined proper placement. Other validation operations are contemplated.

The optional additional processing may be directed by an performed by the remote computing server 134, the autonomous placement device 102, the control or monitoring device 26, or any combination thereof. Subsequently, processing advances to 408.

At 408, if additional control or monitoring devices 26 are to be maintained, processing returns to 404. In the alternative, processing advances to 410.

At 410 the autonomous placement device 102 returns, or is returned, to its starting base or other suitable location. Processing ends at 412.

FIG. 6D is a data flow “clamped” embodiment 500 to maintain a control or monitoring device 26 having a clamp (e.g., the small cell telecommunications device 26v of FIG. 5J, the air quality sensor 26t of FIG. 5K, the distribution transformer monitor 26u of FIG. 5L). The acts of the clamped embodiment 500 may substantially comprise some or all of the acts of the placement embodiment 200, the removal embodiment 300, and the maintain embodiment 400. Processing begins at 502.

At 504, one or more acts of the removal embodiment 300, the placement embodiment 200, and the maintain embodiment 400 are performed. For example, an unmanned vehicle 132 may be deployed, multimedia data (e.g., images, video, audio) may be collected and communicated, one or more fiducial markers may be placed, and other acts may be performed. A remove-and-place system 122 may be configured, a repository 120 may be loaded or unloaded, as the case may be, the autonomous placement device 102 may be coupled to the unmanned vehicle 132 and additionally, or alternatively, a propulsion system for the autonomous placement device 102 may be configured. In at least some cases, the clamped control or monitoring device 26 is not coupled or coupleable to the streetlight luminaire 16. For example, the device may be vertically mounted on a bracket clamped to a utility pole 12. Processing advances to 506.

At 506, a clamp location is identified, and the clamp is engaged or disengaged, as the case may be. The acts to identify the clamp location are along the lines of those described herein with respect to a socket atop a streetlight luminaire 16. That is, one or more cameras may capture still or video images proximate the utility pole 12, streetlight luminaire 16, or support arm 14. Fiducial markers may be placed. Location data, altitude data, data regarding obstacles (e.g., power lines, support cables, climbing pegs, and the like), and other data may be collected and processed. Such information is used to assist the unmanned vehicle 132, or a self-propelled autonomous placement device 102, navigate to the location of the clamp.

The acts to engage or disengage the clamp are along the lines of those described herein with respect to FIGS. 5J-5L. Nuts, bolts, steel straps, and other binding means may be turned, looped, positioned, wrapped, or the like. Brackets, which may be customized to the particular control or monitoring device 26, may be positioned on a utility pole 12, support arm 14, distribution transformer, or other suitable structure. In at least one case, for example, a self-propelled autonomous placement device 102 is arranged to vertically climb a utility pole to a particular height, optionally circumnavigate the utility pole to a particular geographic direction (e.g., the north-facing side of the utility pole), and secure a mounting bracket to the utility pole via screws, adhesive, steel straps, or some other binding means. The autonomous placement device 100 to is further arranged to secure the particular control or monitoring device 26 to the mounting bracket. Processing advances to 508.

At 508, if additional control or monitoring devices 26 are to be maintained, processing returns to 504. In the alternative, processing advances to 510.

At 510 the autonomous placement device 102 returns, or is returned, to its starting base or other suitable location. Processing ends at 512.

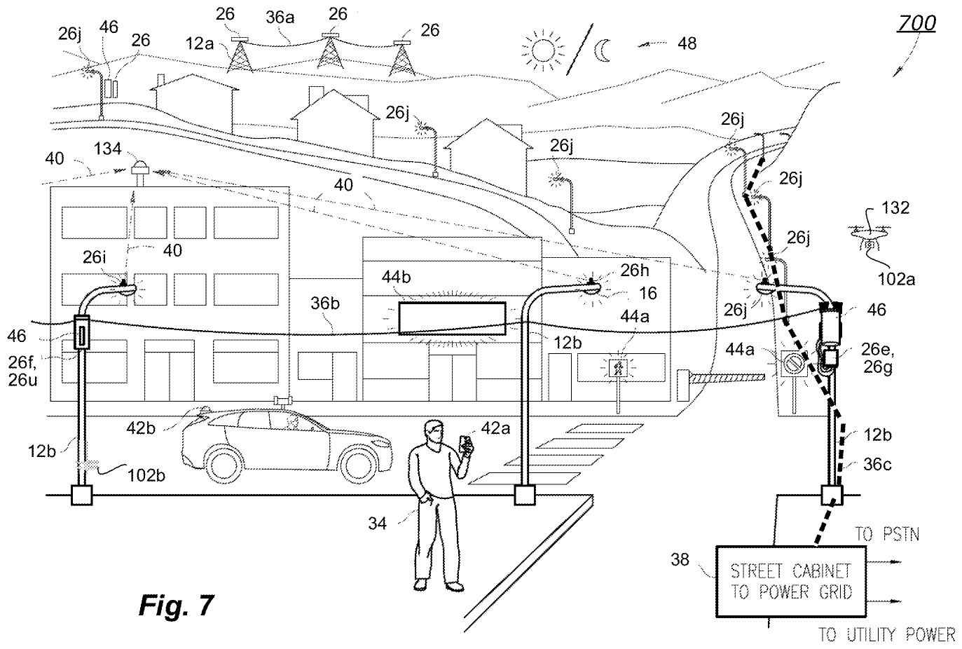

FIG. 7 is a system level deployment 700 of a portion of an electric grid having various control or monitoring device 26 embodiments coupled to corresponding structures of the electric power grid (e.g., power poles 12, streetlight luminaires 16, aerially mounted and sub-station housed distribution transformers, and the like). Certain ones and still more of the electric power industry structure monitor embodiments represented in FIG. 7 are illustrated in other FIGS. of the present disclosure and described in greater detail in the corresponding portions of the disclosure.

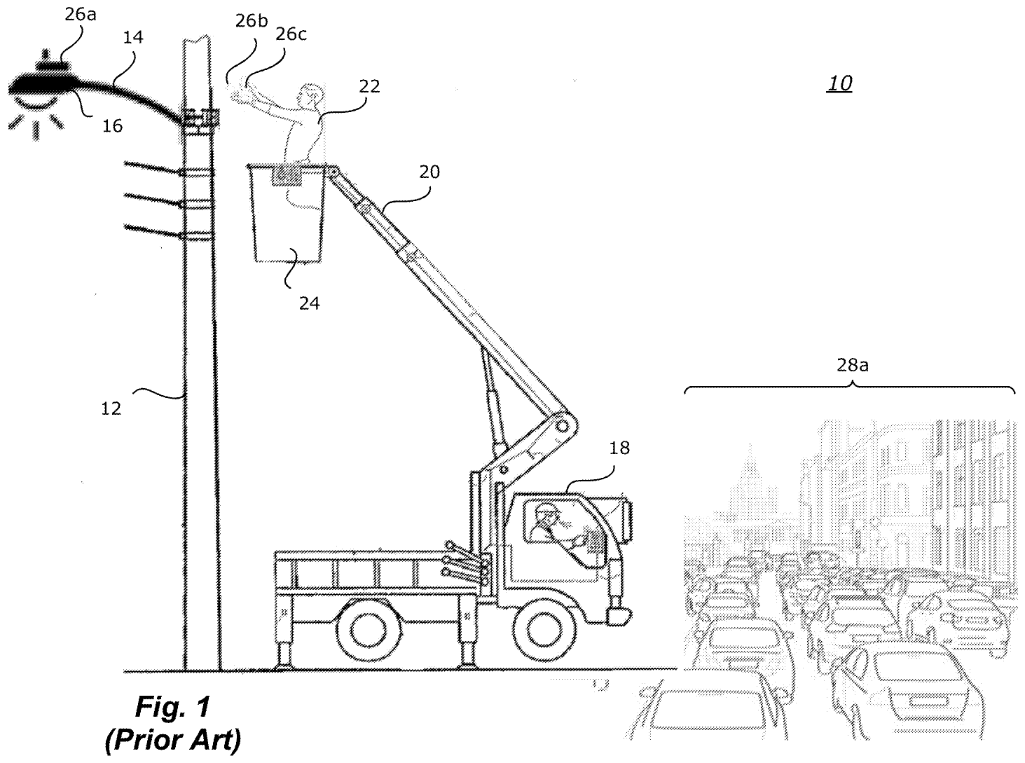

In the system level deployment 700, a plurality of utility poles 12a, 12b are arranged in one or more determined geographic areas. The power poles 12a of FIG. 7 are arranged as high-tension power poles; the power poles 12b of FIG. 7 are generally like the power pole 12 of FIGS. 1-3. In at least some embodiments where the power pole includes a streetlight luminaire 16, the luminaire 16 has at least one light source positioned in a fixture.

Some of the power poles 12 of a power grid may carry power lines 36a, 36b. In other cases, a power grid may include underground power lines 36c. As a point of reference, the light fixtures are at least twenty feet above ground level and in at least some cases, the fixtures are between about 20 feet and 40 feet above ground level. In other cases, the streetlight fixtures may of course be lower than 20 feet above the ground or higher than 40 feet above the ground. In other system level deployments according to the present disclosure, there may be 1,000 or more power poles 12a, 12b arranged in one or more determined geographic areas. In these or in still other cases, the power pole and streetlight luminaires 16 may of course be lower than 20 feet above the ground or higher than 40 feet above the ground. Although described as being above the ground, the various fixtures and control or monitoring device 26 embodiments shown and contemplated in the present disclosure may also be subterranean. For brevity, one of skill in the art will recognize that not each and every one of the power poles 12, streetlight luminaires 16, and control or monitoring devices 26 represented in FIG. 7 is specifically identified.

The power grid of power poles 12, streetlight luminaires 16, streetlight sources, or the like in the system level deployment 700 may be controlled by a utility, a municipality, a public/private partnership, a government agency, or some other publicly affiliated entity. In other cases, the grid of power poles 12, streetlight luminaires 16, streetlight sources, or the like in the system level deployment 700 is controlled by a private entity (e.g., private property owner, third-party service contractor, or the like). In still other cases, a plurality of entities shares control of the grid of power poles, streetlight poles, streetlight fixtures, streetlight sources, or the like. The shared control may be hierarchical or cooperative in some other fashion. For example, when the system or portion of a power grid is controlled by a municipality or a department of transportation, an emergency services agency (e.g., law enforcement, medical services, fire services) may be able to request or otherwise take control of the system. In still other cases, one or more sub-parts of the grid of power poles, streetlight poles, streetlight fixtures, streetlight sources, or the like can be granted some control such as in a neighborhood, around a hospital or fire department, in a construction area, or in some other manner.

In the system level deployment 700 of FIG. 1C, any number of streetlight luminaires 16 may be arranged with a connector that is compliant with a roadway area lighting standard promoted by a standards body. The connector permits the controlling or servicing authority of the system to competitively and efficiently purchase and install control or monitoring devices, such as smart light controllers and small cells, on one or more streetlight luminaires 16. In addition, or in the alternative, the standardized connector in each streetlight fixture permits the controlling or servicing authority to replace conventional light sensors with other devices such as a smart lighting control 26j, 26k-26s, a small cell networking device 26h, 26v, a smart hub device 26i, or some other device.

In the system level deployment 700, a small cell networking device 26h, 26v is electromechanically coupled to a selected light pole 12b wherein the electromechanical coupling is performed via the connector that is compliant with the roadway area lighting standard promoted by a standards body. In some cases, the small cell networking device 26v is also clamped to a support arm. Stated differently, the system level deployment 700 embodied in FIG. 7 includes at least one power pole 12b and streetlight luminaire 16 with a small cell networking device 26h, 26v, and a plurality of power poles 12b each having a smart lighting control device 26j, 26k-26s. In these power poles, each streetlight luminaire is equipped with a standalone control or monitoring device 26 that is electromechanically coupled via a respective connector that is compliant with the roadway area lighting standard promoted by the standards body. Each control or monitoring device 26 is further electrically coupled to a processor-based light control circuit. In at least some of these embodiments, electrically coupling the light sensor to the processor-based light control circuit includes passing a signal representing an amount of light detected by the light sensor to the processor-based light control circuit. In at least some of these embodiments, the light sensor is arranged to detect an amount of lux, lumens, or other measurement of luminous flux and generate the signal representing the amount of light detected.

The processor-based light control circuit of each smart device is arranged to provide a light control signal to the respective light source based on at least one ambient light signal generated by its associated the light sensor. In addition, because each control or monitoring device 26 is equipped with communication capabilities, each streetlight having an associated control or monitoring device 26 can be controlled remotely as an independent light source or in combination with other light sources. In these cases, each of the plurality of power poles 12 and streetlight luminaires 16 with a control or monitoring device 26 is communicatively coupled to the power pole 12 and streetlight luminaire 16 with a small cell networking device 26h, 26v. The communicative relationship from each of the plurality of power poles 12 and streetlight luminaires 16 with a control or monitoring device 26 to the power pole 12 and streetlight luminaire 16 with a small cell networking device 26h, 26v may be a direct communication or an indirect communication. That is, in some cases, one of the plurality of power poles 12 and streetlight luminaires 16 with a control or monitoring device 26 may communicate directly to the power pole 12 and streetlight luminaire 16 with a small cell networking device 26h, 26v, or the one of the plurality of power poles and light fixtures with a control or monitoring device 26 may communicate via one or more other ones of the plurality of power poles 12 and streetlight luminaires with a smart lighting control device 26j, 26k-26s.

In the system level deployment 700 of FIG. 7, various ones of the high-power poles 12a may be 250 feet apart, 500 feet apart, 1000 feet apart, 1500 feet apart, or some other distance. In the system level deployment 700 of FIG. 7, various ones of the distribution power poles 12b may be 50 feet apart, 100 feet apart, 250 feet apart, or some other distance. In some cases, the type and performance characteristics of each small cell networking device 26h, 26v and each smart lighting control device 26j, 26k-26s are selected based on their respective distance to other such devices such that wireless communications are acceptable.

In some cases of a power grid, some power poles 12b and streetlight luminaires with a control or monitoring device 26 are coupled to a street cabinet 38 or other surface-mounted or subterranean structure that provides utility power (e.g., “the power grid”) in a wired way. In these and other cases of a power grid, some power poles 12b and streetlight luminaires 16 with a control or monitoring device 26 may be coupled to utility power in another way. The utility power may provide 120 VAC, 208 VAC, 220 VAC, 240 VAC, 260 VAC, 277 VAC, 360 VAC, 415 VAC, 480 VAC, 600 VAC, or some other power source voltage.

In some cases, a power pole 12b and streetlight luminaire 16 with a smart lighting control device 26j, 26k-26s, and optionally one or more of the power poles 12b and streetlight luminaires 16 with a small cell 26h, 26v, is also coupled to the same street cabinet 38 or another structure that provides a wired telecommunication backhaul connection. It is understood that these wired connections are in some cases separate wired connections (e.g., copper wire, fiber optic cable, industrial Ethernet cable, or the like) and in some cases combined wired connections (e.g., power over Ethernet (PoE), powerline communications, or the like). For simplification of the system level deployment 700 of FIG. 7, the wired backhaul and power line 36c is illustrated as a single line. The street cabinet 38 is coupled to the power grid, which is administered by a licensed power utility agency, and the street cabinet 38 is coupled to the public switched telephone network (PSTN).

In some embodiments, any number of control or monitoring devices 26 are arranged to provide utility grade power metering functions. The utility grade power metering functions may be performed with a circuit arranged to apply any one or more of a full load, a partial load, and a load where voltage and current are out of phase (e.g., 60 degrees; 0.5 power factor). Other metering methodologies are also contemplated. In at least some cases, the power metering functions are used to determine where faults have occurred or where faults are imminent. In such cases, the control or monitoring device 26 may be deployed to monitor a power grid and communicate appropriate alerts thereby improving safety of the power grid.

Each power pole 12 and streetlight luminaire 16 with a smart lighting control 26j, 26k-26s may be in direct or indirect wireless communication with the power pole 12 and streetlight luminaire 16 that has the small cell networking device 26h, 26b. In addition, each power pole 12 and streetlight luminaire 16 with a smart lighting control device 26j, 26k-26s and the power pole 12b and streetlight luminaire 16 with the small cell networking device 26h, 26v may also be in direct or indirect wireless communication 40 with an optional remote computing device 134. The remote computing device 134 may be controlled by a utility, a municipality, a private entity such as a mobile network operator (MNO), another government agency, another third party, or some other entity. By this optional arrangement, the remote computing device 134 can be arranged to wirelessly communicate light control signals and any other information (e.g., packetized data) between itself and each respective control or monitoring device 26 coupled to any of the plurality of power poles.

Other devices may also communicate through power pole-based devices of the system level deployment 700. These devices may be internet of things (IoT) devices or some other types of devices. In FIG. 7, two public information signs 26a, and a private entity sign 26b are shown, but many other types of devices are contemplated. Each one of these devices may form an unlicensed wireless communication session (e.g., Wi-Fi) or a cellular-based wireless communication session with one or more wireless networks made available by the control or monitoring devices 26 shown in the system level deployment 700 of FIG. 1C.

At least some power poles 12b in the system level deployment 700 of FIG. 7 are arranged with a distribution transformer 46. The distribution transformers 46 may optionally be arranged with a first embodiment of a control or monitoring device 26f, 26u. At least some other power poles 12b are arranged with another embodiment of a control or monitoring device 26e, 26g, 26t. Still other high power poles 12a are arranged with a yet another embodiment of a control or monitoring device 26.

The sun and moon 48 are shown in FIG. 7. Light or the absence of light based on time of day, weather, geography, or other causes provide information (e.g., ambient light) to the light sensors of the power pole mounted devices described in the present disclosure. Based on this information, the associated light sources may be suitably controlled.

A user 34 holding a mobile device 42a is represented in the system level deployment 700 of FIG. 7. A vehicle having an in-vehicle mobile device 42b is also represented. The vehicle may be an emergency service vehicle, a passenger vehicle, a commercial vehicle, a public transportation vehicle, a drone, or some other type of vehicle. The user 34 may use their mobile device 24a to establish a wireless communication session over a cellular-based network controlled by an MNO, wherein packetized wireless data is passed through the power pole 12b and streetlight luminaire 16 with a small cell networking device 26h, 26b. Concurrently, the in-vehicle mobile device 42b may also establish a wireless communication session over the same or a different cellular-based network controlled by the same or a different MNO, wherein packetized wireless data of the second session is also passed through the power pole 12b and streetlight luminaire 16 with a small cell networking device 26h, 26v.

In some cases, the user 34 is a worker designated to configure or otherwise operate an autonomous placement device 102. In some embodiments, a first autonomous placement device 102a is configured as a payload having a coupling means (e.g., a payload-to-UV coupling system, a payload-to-UAV coupling system, or the like) arranged for removable mechanical or electromechanical coupling to an unmanned vehicle 132, which in FIG. 7 is arranged as an unmanned aerial vehicle (e.g., a drone). In at least some of these cases, the first autonomous placement device 102a includes a body structure that is a separate and distinct from the unmanned vehicle 132. In these or other embodiments, the first autonomous placement device 102a may also include a repository having a plurality of storage bays, wherein at least a first one of the storage bays is arranged to removably store a first control or monitoring device 26 arranged to be electromechanically deployed to into a standardized receptacle of an aerial lighting fixture. Optionally, one or more of the storage bays is arranged to store a control or monitoring device 26 that will be removed from a luminaire 16 by the autonomous placement device 102a prior to the electromechanical deployment of the first control or monitoring device 26.

In other embodiments, a second autonomous placement device 102b is configured with a propulsion system 128 (FIG. 4). The second autonomous placement device 102b is arranged to climb the utility pole 12b and place, remove, or remove and replace a control or monitoring device 26 on a vertical portion of the utility pole 12b, on a support arm 14, on a streetlight luminaire 16, or some combination thereof. In these cases, the operations of the autonomous placement device 102a, 102b may be performed by a single worker (e.g., user 34) without closing traffic on a street and without the use of a bucket truck or other lift device.

FIG. 8A is a first embodiment of an unmanned vehicle (UV) 132a. The unmanned vehicle 132a is configured as an unmanned aerial vehicle (UAV). In cases where the unmanned vehicle 132a is arranged for flight, the terms unmanned vehicle (UV) and unmanned aerial vehicle (UAV) may be used interchangeably. The unmanned vehicle 132a has at least one camera device integrated in its lower surface. The unmanned vehicle 132a may be used to perform surveillance and other functions as described in the present disclosure during the removal, placement, or replacement of a control or monitoring device 26.

FIG. 8B is a second embodiment of the unmanned vehicle (UV) 132a. In FIG. 8B, the camera device has been removed, and a new payload has been added. The new payload is arranged as an autonomous placement device 102a that is removably affixed two the unmanned vehicle 132a via a payload-to-UV (e.g., payload-to-UAV) coupling system.

FIGS. 8C-8E are another embodiment of an autonomous placement device 102b.

The autonomous placement device 102b has an onboard propulsion system. Accordingly, the autonomous placement device 102b may operate in some cases without an unmanned vehicle 132. In other cases, the autonomous placement device 102b is removably coupled to an unmanned vehicle 132, and in some of these cases, the autonomous placement device 102b remains coupled to the unmanned vehicle 132 during operations to remove, place, or remove and replace a control or monitoring device 26. In other cases, the autonomous placement device 102b is moved into a suitable position (e.g., on the surface of a luminaire 16, onto a support arm 14, onto a utility pole 12, into a street cabinet 38, or some other location), and then the autonomous placement device 102b is released from the unmanned vehicle 132. Here, the autonomous placement device 102b will perform actions to place, remove, or remove and replace a control or monitoring device 26, and subsequently, the autonomous placement device 102b will be rejoined to an unmanned vehicle 132 to return to its base or other desired location.

In FIG. 8C, the autonomous placement device 102b is physically coupled to a utility pole 12 in an extension state. A lower set of arms of the autonomous placement device 102b are drawn into a closed position and physical contact with the utility pole 12, and an upper set of arms were placed in an open state and extended upwards. In FIG. 8D, the upper set of arms have been drawn into the closed position, in the lower set of arms were placed in an open state and retracted upwards. FIG. 8E is a perspective view of the arms portions of the autonomous placement device 102b of FIG. 8D. The upper arms remain in the closed state thereby holding the device onto the utility pole 12, and the lower arms remain in the open state having just been retracted upwards.

FIG. 8F is yet one more embodiment of an autonomous placement device 102c. The autonomous placement device 102c has a transport means arranged to drive the device via a set of “tracks.” The autonomous placement device 102c of FIG. 8F may be suitable for subterranean operations, street cabinet operations, or other circumstances where ground or below-ground placement of a control or monitoring device 26 is difficult, impossible, unsafe, or undesirable for other reasons.

To simplify the illustrations of FIGS. 8A-8F, internal portions of the autonomous placement devices 102a, 102b, 102c are not shown. Embodiments of the autonomous placement devices 102a, 102b, 102c are arranged in accordance with the autonomous placement device 102 of FIG. 4.

Having now set forth certain embodiments, further clarification of certain terms used herein may be helpful to providing a more complete understanding of that which is considered inventive in the present disclosure.

In some cases, a control or monitoring device 26 is configured as a smart lighting control 26j, 26k-26s FIGS. 2, 3, 5A-5I. The smart lighting control is arranged to turn on a light source in a streetlight luminaire 16 when the space proximate the luminaire 16 is determined to be dark or at other times. The smart lighting control is further arranged to turn off the light source in the streetlight luminaire when the space proximate the luminaire 16 is determined to be light or at other times. Optionally, a smart lighting control has communication capabilities (e.g., a cellular transceiver, a power over ethernet interface, a powerline communications interface, a Wi-Fi interface, a serial interface, or the like). The communication capabilities are arranged to receive control information from a remote computing source. The communication capabilities may further be arranged to provide generated or otherwise collected data to a remote computing source. The smart lighting control may include utility grade metering capabilities to capture data representative of electricity volume entering the luminaire 16 or smart lighting control 26 and further representative of electricity volume exiting the luminaire 16 or smart lighting control 26. Optionally, a smart lighting control may include location circuitry (e.g., GPS circuitry, GLONASS circuitry, BeiDou circuitry, signal triangulation circuitry, or the like), computational circuitry, functional software, or any other desirable operational logic.

In some cases, a control or monitoring device 26 is configured as a tilt sensor 26e (FIG. 2). A tilt sensor is arranged to detect vibration, impact, vertical integrity (e.g., tilt), or other circumstantial conditions of the utility pole 12 to which the tilt sensor is mounted. In some cases, the tilt sensor is directly coupled to a utility pole 12 using any suitable binding means (e.g., screws, nails, an adhesive, strapping, or the like). In other cases, the tilt sensor is coupled to a bracket, which bracket is attached to the utility pole 12 via any suitable binding means. A tilt sensor may have at least one self-sustaining power source. Accordingly, the tilt sensor in this configuration may not need to rely on a wired external power source to operate. The tilt sensor has communication capabilities (e.g., a cellular transceiver, a power over ethernet interface, a powerline communications interface, a Wi-Fi interface, a serial interface, or the like). The communication capabilities are arranged to receive control information from a remote computing source. The communication capabilities is further be arranged to provide generated or otherwise collected data to a remote computing source.

In some cases, a control or monitoring device is configured as a distribution transformer monitor 26f, 26u (FIGS. 2, 5L). The distribution transformer monitor may be mounted on a bracket, which bracket is mounted on a wall of a distribution transformer monitor. The distribution transformer monitor is arranged to collect data about the distribution transformer. For example, in at least some cases, the distribution transformer monitor has an infrared camera device aimed at a vessel wall of the distribution transformer. Processing technology in or associated with the distribution transformer monitor is arranged to determine the level of nonconductive medium (e.g., oil) that the distribution transformer vessel contains based on temperature data collected at the vessel wall. The distribution transformer monitor may further include circuitry (e.g., one or more Rogowski coils) arranged to capture electrical current information associated with operation of the distribution transformer. Other data associated with the distribution transformer may also be collected by the distribution transformer monitor. The distribution transformer monitor has communication capabilities (e.g., a cellular transceiver, a power over ethernet interface, a powerline communications interface, a Wi-Fi interface, a serial interface, or the like). The communication capabilities are arranged to receive control information from a remote computing source. The communication capabilities may further be arranged to provide generated or otherwise collected data to a remote computing source.

In some cases, a control or monitoring device is configured as an air quality sensor or other environmental sensor 26g, 26t (FIGS. 2, 5K). The air quality sensor or environmental sensor includes electronic circuitry arranged to sample ambient air for toxins, pollutants, particulates, or other substances. The sensors may further be arranged to capture temperature information, light information, moisture information, pressure information, audio information, video information, tactile information, or any other suitable information regarding the air or environment around a selected utility pole 12. In some cases, the air quality sensor or environmental sensor is directly coupled to a utility pole 12 using any suitable binding means (e.g., screws, nails, an adhesive, strapping, or the like). In other cases, the air quality sensor or environmental sensor is coupled to a bracket, which bracket is attached to the utility pole 12 via any suitable binding means. The air quality sensor or other environmental sensor has communication capabilities (e.g., a cellular transceiver, a power over ethernet interface, a powerline communications interface, a Wi-Fi interface, a serial interface, or the like). The communication capabilities are arranged to receive control information from a remote computing source. The communication capabilities may further be arranged to provide generated or otherwise collected data to a remote computing source.

In some cases, a control or monitoring device is configured as a telecommunications small cell 26h, 26v (FIGS. 2, 5J). The telecommunications small cell may be arranged in concert with a baseband unit or other portions of cellular wireless technology infrastructure. The telecommunications small cell may form communicative coupling relationships with one or more mobile devices to facilitate voice communications, data communications, or other communications. In at least one case, the telecommunications small cell is electromechanically coupled to a standardized socket atop a streetlight luminaire 16, and the telecommunications small cell is further clamped to a support arm associated with the streetlight luminaire 16. The telecommunications a small cell has additional communication capabilities (e.g., a cellular transceiver, a power over ethernet interface, a powerline communications interface, a Wi-Fi interface, a serial interface, or the like). The communication capabilities are arranged to receive control information from a remote computing source. The communication capabilities may further be arranged to provide generated or otherwise collected data to a remote computing source.

In these or other cases, telecommunications small cells are generally understood as part of the network infrastructure of a mobile network operator (MNO). Mobile network operators (MNOs) provide wireless cellular-based services in accordance with one or more cellular-based technologies, and in accordance with one or more cellular telecom protocols. As used in the present disclosure, “cellular-based” should be interpreted in a broad sense to include any of the variety of technologies that implement wireless or mobile communications. Exemplary cellular-based systems and protocols include, but are not limited to, time division multiple access (“TDMA”) systems, code division multiple access (“CDMA”) systems, and Global System for Mobile communications (“GSM”) systems. Some others of these technologies are conventionally referred to as UMTS, WCDMA, 4G, 5G, and LTE. Still other cellular-based technologies are also known now or will be known in the future. The underlying cellular-based technologies and corresponding protocols are mentioned here for a clearer understanding of the present disclosure, but the inventive aspects discussed herein are not limited to any particular cellular-based technology unless expressly stated as such.

In some cases, a control or monitoring device is configured as a smart hub device 26i (FIG. 2). The smart hub includes any suitable number of sensors arranged to capture information in an area around the utility pole on which the smart hub is mounted. For example, a smart hub device may include one or more cameras, one or more microphones, accelerometers, thermometers, pressure sensors, and the like. Information produced by the sensors of the smart hub device may be passed through suitable artificial intelligence engines to produce machine or human useful information such as traffic information, accident information, criminal information, environmental information, and the like. In at least one case, a smart hub includes one or a plurality of Wi-Fi transceivers arranged to provide public wide area network (WAN) access, such as Internet access. The smart hub device has communication capabilities (e.g., a cellular transceiver, a power over ethernet interface, a powerline communications interface, a Wi-Fi interface, a serial interface, or the like). The communication capabilities are arranged to receive control information from a remote computing source. The communication capabilities may further be arranged to provide generated or otherwise collected data to a remote computing source.

In the present disclosure, for brevity, any one or more of the control or monitoring devices 26a-26u may be individually or collectively referred to as a control or monitoring device 26.

A mobile device, or mobile computing device, as the terms are used interchangeably herein, is an electronic device provisioned by at least one mobile network operator (MNO) to communicate data through the MNO's cellular-based network. The data may be voice data, short message service (SMS) data, electronic mail, world-wide web or other information conventionally referred to as “internet traffic,” or any other type of electromagnetically communicable information. The data may be digital data or analog data. The data may be packetized or non-packetized. The data may be formed or passed at a particular priority level, or the data may have no assigned priority level at all. A non-comprehensive, non-limiting list of mobile devices is provided to aid in understanding the bounds of the term, “mobile device,” as used herein. Mobile devices (i.e., mobile computing devices) include cell phones, smart phones, flip phone, tablets, phablets, handheld computers, laptop computers, body-worn computers, and the like. Certain other electronic equipment in any form factor may also be referred to as a mobile device when this equipment is provisioned for cellular-based communication on an MNO's cellular-based network. Examples of this other electronic equipment include in-vehicle devices, medical devices, industrial equipment, retail sales equipment, wholesale sales equipment, utility monitoring equipment, and other such equipment used by private, public, government, and other entities.

Mobile devices further have a collection of input/output ports for passing data over short distances to and from the mobile device. For example, serial ports, USB ports, Wi-Fi ports, Bluetooth ports, IEEE 1394 FireWire, and the like can communicatively couple the mobile device to other computing apparatuses.

Mobile devices have a battery or other power source, and they may or may not have a display. In many mobile devices, a signal strength indicator is prominently positioned on the display to provide network communication connectivity information to the mobile device user.

A cellular transceiver is used to couple the mobile device to other communication devices through the cellular-based communication network. In some cases, software and data in a file system are communicated between the mobile device and a computing server via the cellular transceiver. That is, bidirectional communication between a mobile device and a computing server is facilitated by the cellular transceiver. For example, a computing server may download a new or updated version of software to the mobile device or any of the control or monitoring devices 26 over the cellular-based communication network. As another example, the mobile device may communicate any other data to the computing server over the cellular-based communication network.

Each mobile device client, and each control or monitoring device 26 described herein, has electronic memory accessible by at least one processing unit within the device. The memory is programmed with software that directs the one or more processing units. Some of the software modules in the memory control the operation of the mobile device or control or monitoring device 26 with respect to generation, collection, and distribution or other use of data. In some cases, software directs the collection of individual datums, and in other cases, software directs the collection of sets of data.

Software may include a fully executable software program, a simple configuration data file, a link to additional directions, or any combination of known software types. When the computing server updates the software of a mobile device or control or monitoring device 26, the update may be small or large. For example, in some cases, a computing server downloads a small configuration data file to a mobile device or control or monitoring device 26 as part of software, and in other cases, the computing server completely replaces all of the software present on the mobile device or control or monitoring device 26 with a fresh version. In some cases, software, data, or software and data is encrypted, encoded, and/or otherwise compressed for reasons that include security, privacy, data transfer speed, data cost, or the like.

Database structures, if any are present in the control or monitoring devices 26 or remote computing servers described herein, may be formed in a single database or multiple databases. In some cases, hardware or software storage repositories are shared amongst various functions of the particular system or systems to which they are associated. A database may be formed as part of a local system or local area network. Alternatively, or in addition, a database may be formed remotely, such as within a distributed “cloud” computing system, which would be accessible via a wide area network or some other network.

Processing devices, which may also be referred to in the present disclosure as “processing circuits,” “processors,” or another like term, include central processing units (CPU's), microprocessors, microcontrollers (MCU), digital signal processors (DSP), application specific integrated circuits (ASIC), state machines, and the like. One or more processors working cooperatively may be referred to in the singular (e.g., as a processor) without departing from the inventive concepts disclosed herein. Accordingly, a processor as described herein includes any device, system, or part thereof that controls at least one operation, and such a device may be implemented in hardware, firmware, or software, or some combination of at least two of the same. The functionality associated with any particular processor may be centralized or distributed, whether locally or remotely. A processor may interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, one or more embodiments describe software executable by the processor or processing circuit, which when executed, carries out one or more of the method acts taught in the present disclosure.

The present disclosure discusses several embodiments that include or otherwise cooperate with one or more computing devices. It is recognized that these computing devices are arranged to perform one or more algorithms to implement various concepts taught herein. Each of said algorithms is understood to be a finite sequence of steps for solving a logical or mathematical problem or performing a task. Any or all of the algorithms taught in the present disclosure may be demonstrated by formulas, flow charts, data flow diagrams, narratives in the specification, and other such means as evident in the present disclosure. Along these lines, the structures to carry out the algorithms disclosed herein include at least one processing device executing at least one software instruction retrieved from at least one memory device. The structures may, as the case may be, further include suitable input circuits known to one of skill in the art (e.g., keyboards, buttons, memory devices, communication circuits, touch screen inputs, and any other integrated and peripheral circuit inputs (e.g., accelerometers, thermometers, light detection circuits and other such sensors)), suitable output circuits known to one of skill in the art (e.g., displays, light sources, audio devices, tactile devices, control signals, switches, relays, and the like), and any additional circuits or other structures taught in the present disclosure. To this end, every invocation of means or step plus function elements in any of the claims, if so desired, will be expressly recited.

In some cases, the processor or processors described in the present disclosure, and additionally more or fewer circuits of the exemplary computing devices described in the present disclosure, may be provided in an integrated circuit. In some embodiments, all of the elements shown in the processors of the present figures (e.g., processor 104 of FIG. 4) may be provided in an integrated circuit. In alternative embodiments, one or more of the arrangements depicted in the present figures may be provided by two or more integrated circuits. Some embodiments may be implemented by one or more dies. The one or more dies may be packaged in the same or different packages. Some of the depicted components may be provided outside of an integrated circuit or die.

The processors shown in the present figures and described herein may be fixed at design time in terms of one or more of topology, maximum available bandwidth, maximum available operations per unit time, maximum parallel execution units, and other such parameters. Some embodiments of the processors may provide re-programmable functionality (e.g., reconfiguration of embedded processor modules and features to implement an artificial intelligence engine as taught herein) at run-time. Some or all of the re-programmable functionality may be configured during one or more initialization stages. Some or all of the re-programmable functionality may be configured, re-configured, or otherwise configured in real time with no latency, maskable latency, or an acceptable level of latency.

As known by one skilled in the art, a computing device, including a mobile computing device and a control or monitoring device 26, has one or more memories, and each memory may comprise any combination of volatile and non-volatile computer-readable media for reading and writing. Volatile computer-readable media includes, for example, random access memory (RAM). Non-volatile computer-readable media includes, for example, any one or more of read only memory (ROM), magnetic media such as a hard-disk, an optical disk, a flash memory device, a CD-ROM, and the like. In some cases, a particular memory is separated virtually or physically into separate areas, such as a first memory, a second memory, a third memory, etc. In these cases, it is understood that the different divisions of memory may be in different devices or embodied in a single memory. Some or all of the stored contents of a memory may include software instructions executable by a processor to carry out one or more particular acts.

In the present disclosure, memory may be used in one configuration or another. The memory may be configured to store data. In the alternative or in addition, the memory may be a non-transitory computer readable medium (CRM) wherein the CRM is configured to store instructions executable by a processor. The instructions may be stored individually or as groups of instructions in files. The files may include functions, services, libraries, and the like. The files may include one or more computer programs or may be part of a larger computer program. Alternatively, or in addition, each file may include data or other computational support material useful to carry out the computing functions of the systems, methods, and apparatus described in the present disclosure.

The computing devices and control or monitoring devices 26 illustrated herein may further include operative software found in a conventional computing device such as an operating system or task loop, software drivers to direct operations through I/O circuitry, networking circuitry, and other peripheral component circuitry. In addition, the computing devices may include operative application software such as network software for communicating with other computing devices, database software for building and maintaining databases, and task management software where appropriate for distributing the communication and/or operational workload amongst various processors. In some cases, the computing device is a single hardware machine having at least some of the hardware and software listed herein, and in other cases, the computing device is a networked collection of hardware and software machines working together in a server farm to execute the functions of one or more embodiments described herein. Some aspects of the conventional hardware and software of the computing devices and control or monitoring devices 26 is not shown in the figures for simplicity.

Amongst other things, at least certain ones of the exemplary computing devices of the present disclosure (e.g., remote computing server 134 and each of the control or monitoring devices 26) may be configured in any type of mobile or stationary computing device such as a remote cloud computer, a computing server, a smartphone, a tablet, a laptop computer, a wearable device (e.g., eyeglasses, jacket, shirt, pants, socks, shoes, other clothing, hat, helmet, other headwear, wristwatch, bracelet, pendant, other jewelry), vehicle-mounted device (e.g., train, plane, helicopter, unmanned aerial vehicle, unmanned underwater vehicle, unmanned land-based vehicle, automobile, motorcycle, bicycle, scooter, hover-board, other personal or commercial transportation device), industrial device (e.g., factory robotic device, home-use robotic device, retail robotic device, office-environment robotic device), or the like. Accordingly, the computing devices include other components and circuitry that is not illustrated, such as, for example, a display, a network interface, memory, one or more central processors, camera interfaces, audio interfaces, and other input/output interfaces. In some cases, the exemplary computing devices may also be configured in a different type of low-power device such as a mounted video camera, an Internet-of-Things (IoT) device, a multimedia device, a motion detection device, an intruder detection device, a security device, a crowd monitoring device, or some other device.

Input/output (I/O) circuitry and user interface (UI) modules include serial ports, parallel ports, universal serial bus (USB) ports, IEEE 802.11 transceivers and other transceivers compliant with protocols administered by one or more standard-setting bodies, displays, projectors, printers, keyboards, computer mice, microphones, micro-electro-mechanical (MEMS) devices such as accelerometers, and the like.

Buttons, keypads, computer mice, memory cards, serial ports, bio-sensor readers, touch screens, and the like may individually or in cooperation be useful to a user installing, maintaining, operating, overseeing, managing, or otherwise interested in the distribution transformer monitors of the present disclosure. The devices may, for example, input control information into the system. Displays, printers, memory cards, LED indicators, temperature sensors, audio devices (e.g., speakers, piezo device, etc.), vibrators, and the like are all useful to present output information to users of the distribution transformer monitors taught in the present disclosure. In some cases, the input and output devices are directly coupled to one or more processors 162 (FIGS. 4, 8) and electronically coupled to a processor or other operative circuitry. In other cases, the input and output devices pass information via one or more communication ports (e.g., RS-232, RS-485, infrared, USB, etc.).

In at least one embodiment, devices such as the computing server 134 and control or monitoring devices 26 may communicate with other devices via communication over a network. The network may involve an Internet connection or some other type of local area network (LAN) or wide area network (WAN). Non-limiting examples of structures that enable or form parts of a network include, but are not limited to, an Ethernet, twisted pair Ethernet, digital subscriber loop (DSL) devices, wireless LAN, Wi-Fi, 4G, LTE, 5G, or the like.

FIGS. 6A-6D are data flow diagrams 200-500 illustrating one or more non-limiting processes that may be used by embodiments of computing devices such as the control or monitoring devices 26 deployed on a light pole, power pole, in a vault, or in some other setting. In this regard, each described process may represent a module, segment, or portion of code, which comprises one or more executable instructions for implementing the specified logical function(s). It should also be noted that in some implementations, the functions noted in the process may occur in a different order, may include additional functions, may occur concurrently, and/or may be omitted.

The figures in the present disclosure illustrate portions of one or more non-limiting computing device embodiments such as one or more components of computing server 134 and one or more components of the particular control or monitoring device 26. The computing devices may include operative hardware found in conventional computing device apparatuses such as one or more processors, volatile and non-volatile memory, serial and parallel input/output (I/O) circuitry compliant with various standards and protocols, wired and/or wireless networking circuitry (e.g., a communications transceiver), one or more user interface (UI) modules, logic, and other electronic circuitry.

The present disclosure discusses several embodiments that include or otherwise cooperate with one or more computing devices. It is recognized that these computing devices are arranged to perform one or more algorithms to implement the inventive concepts taught herein. Each of said algorithms is understood to be a finite sequence of steps for solving a logical or mathematical problem or performing a task. Any or all of the algorithms taught in the present disclosure may be demonstrated by formulas, flow charts, data flow diagrams, narratives in the specification, and other such means as evident in the present disclosure. Along these lines, the structures to carry out the algorithms disclosed herein include at least one processor executing at least one software instruction retrieved from at least one memory device. The structures may, as the case may be, further include suitable input circuits known to one of skill in the art (e.g., keyboards, buttons, memory devices, communication circuits, touch screen inputs, and any other integrated and peripheral circuit inputs (e.g., accelerometers, thermometers, light detection circuits and other such sensors)), suitable output circuits known to one of skill in the art (e.g., displays, light sources, audio devices, tactile devices, control signals, switches, relays, and the like), and any additional circuits or other structures taught in the present disclosure. To this end, every invocation of means or step plus function elements in any of the claims, if so desired, will be expressly recited.

As used in the present disclosure, the term “module” refers to an application specific integrated circuit (ASIC), an electronic circuit, a processor and a memory operative to execute one or more software or firmware programs, combinational logic circuitry, or other suitable components (hardware, software, or hardware and software) that provide the functionality described with respect to the module.

The terms, “real-time” or “real time,” as used herein and if used in the claims that follow, are not intended to imply instantaneous processing, transmission, reception, or otherwise as the case may be. Instead, the terms, “real-time” and “real time” imply that the activity occurs over an acceptably short period of time (e.g., over a period of microseconds or milliseconds), and that the activity may be performed on an ongoing basis (e.g., recording and reporting the collection of utility grade power metering data, recording and reporting IoT data, crowd control data, anomalous action data, and the like). An example of an activity that is not real-time is one that occurs over an extended period of time (e.g., hours or days)] or that occurs based on intervention or direction by a person or other activity.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a certain control or monitoring device 26e, 26g may be described as being mounted “substantially vertical” on a utility pole 12. In these cases, a device that is mounted exactly vertical is mounted along an “X” axis and a “Y” axis that is normal (i.e., 90 degrees or at right angle) to a plane or line formed by a “Z” axis. Different from the exact precision of the term, “vertical,” and the use of “substantially” or “about” to modify the characteristic permits a variance of the particular characteristic by up to 30 percent. As another example, a certain control or monitoring device 26 housing has a particular linear dimension of between about five (5) inches and fourteen (14) inches. Here use of “about” permits the dimension to vary by up to 30 percent. Accordingly, the particular linear dimension of the certain control or monitoring device 26 housing may be between 0.8 inches and 18.2 inches.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, the technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

In the present disclosure, when an element (e.g., component, circuit, device, apparatus, structure, layer, material, or the like) is referred to as being “on,” “coupled to,” or “connected to” another element, the elements can be directly on, directly coupled to, or directly connected to each other, or intervening elements may be present. In contrast, when an element is referred to as being “directly on,” “directly coupled to,” or “directly connected to” another element, there are no intervening elements present.

The terms “include” and “comprise” as well as derivatives and variations thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the present disclosure, the terms first, second, etc., may be used to describe various elements, however, these elements are not limited by these terms unless the context clearly requires such limitation. Instead, these terms are only used to distinguish one element from another. For example, a first machine could be termed a second machine, and, similarly, a second machine could be termed a first machine, without departing from the scope of the inventive concept.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or ideas.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

As described herein, for simplicity, a user is in some case described in the context of the male gender. For example, the terms “his,” “him,” and the like may be used. It is understood that a user can be of any gender, and the terms “he,” “his,” and the like as used herein are to be interpreted broadly inclusive of all known gender definitions.

As the context may require in this disclosure, except as the context may dictate otherwise, the singular shall mean the plural and vice versa; all pronouns shall mean and include the person, entity, firm or corporation to which they relate; and the masculine shall mean the feminine and vice versa.

When so arranged as described herein, each computing device may be transformed from a generic and unspecific computing device to a combination device comprising hardware and software configured for a specific and particular purpose. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The embodiments described herein use computerized technology to improve the maintenance, placement, removal, and replacement of control or monitoring devices 26 on an electric power industry structure such as a utility pole and a distribution transformer, but other techniques and tools remain available to monitor such structures. Therefore, the claimed subject matter does not foreclose the whole or even substantial electric power industry structure control or monitoring technological area. The innovation described herein uses both new and known building blocks combined in new and useful ways along with other structures and limitations to create something more than has heretofore been conventionally known. The embodiments improve on computing systems which, when un-programmed or differently programmed, cannot perform or provide the specific control or monitoring device features claimed herein. The embodiments described in the present disclosure improve upon known electrical device monitoring processes and control techniques. The computerized acts described in the embodiments herein are not purely conventional and are not well understood. Instead, the acts are new to the industry. Furthermore, the combination of acts as described in conjunction with the present embodiments provides new information, motivation, and business results that are not already present when the acts are considered separately. There is no prevailing, accepted definition for what constitutes an abstract idea. To the extent the concepts discussed in the present disclosure may be considered abstract, the claims present significantly more tangible, practical, and concrete applications of said allegedly abstract concepts. And said claims also improve previously known computer-based systems that perform electrical device control or monitoring operations.

The various embodiments described above can be combined to provide further embodiments. Aspects of the embodiments can be modified, if necessary, to employ concepts of the various patents, application and publications to provide yet further embodiments.

In the embodiments of present disclosure, one or more particular control or monitoring devices 26 are arranged to generate data associated with certain conditions that exist in and around streetlights or other electric power industry structures such as a distribution transformer. The various components and devices of the embodiments are interchangeably described herein as “coupled,” “connected,” “attached,” and the like.

The autonomous placement of a device atop a streetlight described in the present disclosure provides several technical effects and advances to the fields of energy efficiency, security, telecommunications, and the provision of public services.

Technical effects and benefits include the ability to add a control device to the top of a streetlight, and in some cases, first remove an existing control device from the top of the streetlight. For example, in at least one embodiment, it is determined that a lighting control device will be added to the top of an existing streetlight. Historically, the work to add the controller would require 1) approval from one or more governmental authorities, 2) closing all or at least a portion of the roadway proximate the streetlight of interest, 3) rolling a bucket truck into position, 4) positioning a human worker in the bucket of the bucket truck, 5) raising the bucket to aerially position the worker next to the streetlight, 6) manually removing an existing controller (if one is present) and placing the new controller, 7) returning the worker to ground level, and 8) restoring traffic flow on the roadway. In contrast, the present inventors envision that use of the teaching in the present disclosure will eliminate nearly all of these steps. Approval for the work from the entity responsible for the streetlight will still be needed, but permits to close a roadway, closure of a roadway, and use of a bucket truck and skilled operator of the truck can now be avoided. Instead, an autonomous placement device as taught herein can safely, quickly, and efficiently perform the task. What's more, autonomous placement device embodiments described in the present disclosure may be arranged to place smart lighting controllers, telecommunications equipment, public safety equipment, public services equipment, and nearly any other controller that would otherwise be placed with a human worker in a bucket truck. In at least some cases, the autonomous placement device is a payload deployed with an unmanned aerial vehicle (e.g., UAV, drone, and the like). In other cases, the autonomous placement device has a transport means (e.g., wheels, tracks, propellers, clamps, straps, spikes, articulated or otherwise mechanical arms (or legs, or fingers, or the like), adhesives, an engine, a motor, a guidance system, a tracking system, and the like) that is arranged to self-position the autonomous placement device at the location of interest (e.g., atop a streetlight luminaire, a light-post, in a utility vault, or the like).

The present disclosure sets forth details of various structural embodiments that may be arranged to carry the teaching of the present disclosure. By taking advantage of the flexible circuitry, mechanical structures, computing architecture, and communications means described herein, a number of exemplary devices and systems are now disclosed.

Example A-1 is a system, comprising: an autonomous placement device that includes: a remove-and-place system arranged to: temporarily bind itself to a first lighting control device and rotationally disengage the first lighting control device from a standardized receptacle of an aerial lighting fixture, wherein the standardized receptacle is compliant with a roadway area lighting standard promoted by a standards body; and temporarily bind itself to a second lighting control device and rotationally engage the second lighting control device into the standardized receptacle of the aerial lighting fixture; and a repository having a plurality of storage bays, wherein a first one of the storage bays is arranged to store the first lighting control device after the first lighting control device is removed from the standardized receptacle, and wherein a second one of the storage bays is arranged to store the second lighting control device prior to the second lighting control device being deployed into the standardized receptacle; an unmanned aerial vehicle (UAV) that is separate and distinct from the autonomous placement device; and a UAV-to-payload coupling system arranged to mechanically couple the autonomous placement device to the UAV.

Example A-2 may include the subject matter of Example A-1, and alternatively or additionally any other example herein, wherein the standardized receptacle is compliant with an ANSI C136.41a roadway area lighting standard.

Example A-3 may include the subject matter of any of Examples A1 to A-2, and alternatively or additionally any other example herein, wherein the first one of the storage bays is a different storage bay of the plurality of storage bays from the second one of the storage bays.

Example A-4 may include the subject matter of any of Examples A1 to A-3, and alternatively or additionally any other example herein, wherein the remove-and-place system is further arranged to release the second lighting control device into the second one of the storage bays of the repository.

Example A-5 may include the subject matter of any of Examples A1 to A-4, and alternatively or additionally any other example herein, wherein the remove-and-place system arranged to retrieve the first lighting control device from the first one of the storage bays of the repository.

Example A-6 may include the subject matter of any of Examples A1 to A-5, and alternatively or additionally any other example herein, wherein the UAV-to-payload coupling system is integrated with the UAV.

Example A-7 may include the subject matter of any of Examples A1 to A-6, and alternatively or additionally any other example herein, wherein the UAV-to-payload coupling system is integrated with the autonomous placement device.

Example A-8 may include the subject matter of any of Examples A1 to A-7, and alternatively or additionally any other example herein, wherein the autonomous placement device further includes: a propulsion system arranged to propel the autonomous placement device.

Example A-9 may include the subject matter of any of Examples A1 to A-8, and alternatively or additionally any other example herein, wherein the remove-and-place system includes at least one clamping structure arranged to clamp the first and second lighting control devices.

Example A-10 may include the subject matter of any of Examples A1 to A-9, and alternatively or additionally any other example herein, wherein the autonomous placement device includes: a processor; and a memory, wherein the processor is arranged to execute software instructions stored in the memory to: locate the first lighting control device; direct the remove-and-place system to disengage first lighting control device; and temporarily store the first lighting control device in the first storage bay of the repository.

Example A-11 may include the subject matter of any of Examples A1 to A-10, and alternatively or additionally any other example herein, wherein the processor is further arranged to execute software instructions stored in the memory to: retrieve the second lighting control device from the second storage bay of the repository; and direct the remove-and-place system to engage the second lighting control device into the standardized receptacle.

Example A-12 may include the subject matter of any of Examples A-1 to A-11, and alternatively or additionally any other example herein, wherein the payload further comprises

Example A-13 may include the subject matter of any of Examples A-1 to A-12, and alternatively or additionally any other example herein, wherein the autonomous placement device includes a processor and a memory, wherein the processor is arranged to execute software instructions stored in the memory.

Example A-14 may include the subject matter of any of Examples A-1 to A-13, and alternatively or additionally any other example herein, wherein the autonomous placement device optionally includes one or more of an input/output (I/O) module, a user interface, a communications module, a power supply, and artificial intelligence (AI) engine, a repository, a surveillance/guidance module, a propulsion system, and other circuitry.

Example A-15 may include the subject matter of any of Examples A-1 to A-14, and alternatively or additionally any other example herein, wherein a remove-and-place system of the autonomous placement device optionally includes at least one of a clamp, a suction device, and an inflatable device.

Example A-16 may include the subject matter of any of Examples A-1 to A-15, and alternatively or additionally any other example herein, wherein and artificial intelligence engine of the autonomous placement device optionally includes at least one of an image recognition subsystem, a pattern matching subsystem, and an adaptive control subsystem.

Example A-17 may include the subject matter of any of Examples A-1 to A-16, and alternatively or additionally any other example herein, wherein the repository of the autonomous placement device optionally includes one or more open or closed storage bays, the one or more open or closed storage bays arranged as at least one of a carousel, a Ferris wheel, and in in-line storage structure.

Example A-18 may include the subject matter of any of Examples A-1 to A-17, and alternatively or additionally any other example herein, wherein the surveillance guidance module of the autonomous placement device optionally includes one or more cameras, location circuitry (e.g., a global positioning system (GPS)), and a system to place, read, and or generate at least one physical or virtual fiducial marker.

Example A-19 may include the subject matter of any of Examples A-1 to A-18, and alternatively or additionally any other example herein, wherein the propulsion system of the autonomous placement device optionally includes a motor, wheels, tracks, propellers, clamps, mechanical appendages (movable arms, articulating arms, and the like), spikes, adhesives, and other such transport means.

Example A-20 may include the subject matter of any of Examples A-1 to A-19, and alternatively or additionally any other example herein, wherein an optional UV-to-payload coupling system optionally includes one or more of a clamp, a magnet, an electromagnet, an adhesive, a carabiner, a hook, a nut, a bolt, and a hook-and-loop material.

Example A-21 may include the subject matter of any of Examples A-1 to A-20, and alternatively or additionally any other example herein, wherein the unmanned vehicle optionally includes a means of applying downward pressure, said means of applying downward pressure include one or more of downward pressure rotors, configurable rotors, a hydraulic mechanism, a rotational screw mechanism, and the like.

Example A-22 may include the subject matter of any of Examples A-1 to A-21, and alternatively or additionally any other example herein, wherein the autonomous placement device optionally includes a means of applying downward pressure, said means of applying downward pressure include one or more of downward pressure rotors, configurable rotors, a hydraulic mechanism, a rotational screw mechanism, and the like.

Example A-23 may include the subject matter of any of Examples A-1 to A-22, and alternatively or additionally any other example herein, wherein the autonomous placement device includes one or more extended or extendable arms arranged to temporarily clamp onto a streetlight luminaire said one or more extended or extendable arms further optionally arranged to provide a counter torque when a control or monitoring device is placed or removed in a socket integrated in the streetlight luminaire, and the one or more extended or extendable arms further optionally arranged to provide stabilization against downward pressure applied to the control or monitoring device during a placement or removal process.

Example A-24 may include the subject matter of any of Examples A-1 to A-23, and alternatively or additionally any other example herein, wherein one or more cameras of an unmanned vehicle are optionally removable.

Example A-25 may include the subject matter of any of Examples A-1 to A-24, and alternatively or additionally any other example herein, wherein a first unmanned vehicle is arranged to provide surveillance information to support a control or monitoring device placement, removal, or replacement process, and a second unmanned vehicle is arranged to implement the control or monitoring device placement, removal, or replacement process.

Example A-26 may include the subject matter of any of Examples A-1 to A-25, and alternatively or additionally any other example herein, wherein an unmanned vehicle is arranged to provide surveillance information to support a control or monitoring device placement, removal, or replacement process, and the same unmanned vehicle is arranged to implement the control or monitoring device placement, removal, or replacement process.

Example A-27 may include the subject matter of any of Examples A-1 to A-26, and alternatively or additionally any other example herein, wherein control or monitoring device is configured as a smart lighting control device, a smart hub device, a small cell telecommunications device, an air quality sensor, and environmental sensor, or a distribution transformer monitor.

Example B-1 is an autonomous placement device, comprising: a repository arranged to store a plurality of control or monitoring devices; a guidance system arranged to locate a placement position on a utility pole for a first control or monitoring device of the plurality of control or monitoring devices; and a remove-and-place system arranged to: temporarily bind itself to the first control or monitoring device; affix the first control or monitoring device at the placement position; and detach itself from the first control or monitoring device.

Example B-2 may include the subject matter of Example B1, and alternatively or additionally any other example herein, wherein the autonomous placement device further comprises: a housing; and a coupling system arranged to mechanically couple the housing of the autonomous placement device to an unmanned vehicle, the unmanned vehicle arranged to position the autonomous placement device in proximity to the placement position on the utility pole.

Example B-3 may include the subject matter of any of Examples B1 to B-2, and alternatively or additionally any other example herein, wherein the unmanned vehicle is an unmanned aerial vehicle (UAV).

Example B-4 may include the subject matter of any of Examples B1 to B-3, and alternatively or additionally any other example herein, wherein each control or monitoring device of the plurality of control or monitoring devices is a small cell, a distribution transformer monitor, a tilt sensor, or an environmental sensor.

Example B-5 may include the subject matter of any of Examples B1 to B-4, and alternatively or additionally any other example herein, wherein each control or monitoring device of the plurality of control or monitoring devices includes at least one clamp.

Example B-6 may include the subject matter of any of Examples B1 to B-5, and alternatively or additionally any other example herein, wherein the autonomous placement device further comprises: an onboard propulsion system; a surveillance system configured to collect data in an area around the utility pole; an artificial intelligence engine to identify the placement position; and a guidance system to direct the onboard propulsion system to position the remove-and-place system proximate the placement position.

Example C-1 is a method to place a control or monitoring device, comprising: loading a repository of an autonomous placement device with at least one control or monitoring device; configuring a remove-and-place system to temporarily bind itself to the at least one control or monitoring device; coupling the autonomous placement device to an unmanned vehicle; directing the unmanned vehicle to transport the autonomous placement device to a position proximate a streetlight luminaire; and directing the autonomous placement device to rotationally deploy the at least one control or monitoring device into a standardized receptacle of the streetlight luminaire, wherein the standardized receptacle is compliant with a roadway area lighting standard promoted by a standards body.

Example C-2 may include the subject matter of Example C1, and alternatively or additionally any other example herein, wherein the method to further comprises: surveilling the area around the streetlight luminaire prior to directing the unmanned vehicle to transport the autonomous placement device to the position proximate the streetlight luminaire; and establishing at least one fiducial marker to guide at least one of the transport of the autonomous placement device and the directing of the autonomous placement device.

Example C-3 may include the subject matter of any of Examples C1 to C-2, and alternatively or additionally any other example herein, wherein the method further comprises: configuring the remove-and-place system to temporarily bind itself to a second control or monitoring device that will be removed from the streetlight luminaire; configuring the repository to store the second control or monitoring device; directing the autonomous placement device to rotationally remove the second control or monitoring device from the streetlight luminaire; and directing the remove-and-place system to load the second control or monitoring device removed from the streetlight luminaire into the repository.

Example D-1 is a system, comprising an unmanned aerial vehicle (UAV); a UAV-to-payload coupling system integrated with the UAV; a payload arranged as an autonomous placement device that includes: a body structure that is separate and distinct from the UAV; a payload-to-UAV coupling system integrated with the body structure, the payload-to-UAV coupling system arranged for mechanical coupling to the UAV-to-payload coupling system; a repository having a plurality of storage bays, wherein at least a first one of the storage bays is arranged to temporarily store a first lighting control device, the first lighting control device to be electromechanically deployed to into a standardized receptacle of an aerial lighting fixture, the standardized receptacle compliant with a roadway area lighting standard promoted by a standards body, and wherein at least a second one of the storage bays is arranged to temporarily store a second lighting control device, the second lighting control device removed by the autonomous placement device from the aerial lighting fixture prior to the electromechanical deployment of the first lighting control device; and a clamping system arranged to clamp the second lighting control device during removal of the second lighting control device from the aerial lighting fixture by the autonomous placement device, and further arranged to clamp the first lighting control device during electromechanically deployment by the autonomous placement device to into the standardized receptacle of the aerial lighting fixture.

In the description herein, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order to avoid obscuring the description with unnecessary detail. Thus, the present disclosure is not intended to be limited to the embodiments shown but is instead to be accorded the widest scope consistent with the principles and features disclosed herein. Hence, these and other changes can be made to the embodiments in light of the above-detailed description. In general, in the following claims, the terms used should not be construed to limit the claims to the specific embodiments disclosed in the specification but should be construed to include all possible embodiments along with the full scope of equivalents to which such claims are entitled. Accordingly, the claims are not limited by the disclosure.

What is claimed is:

1. A system comprising:
an unmanned aerial vehicle (UAV);
a payload coupling system; and
an autonomous placement device mechanically coupled to the UAV by the payload coupling system, the autonomous placement device including:
a repository arranged to store at least one electronic device; and
a remove-and-place system operable to retrieve an electronic device from the repository and, after the autonomous placement device has been positioned aerially by the UAV, secure the electronic device to an object at an aerial placement position.

2. The system of claim 1, wherein the remove-and-place system is further operable, after the autonomous placement device has been positioned aerially by the UAV, to:
fasten to a second electronic device that is secured to the object or a second object; and
disengage the second electronic device from the object or the second object.

3. The system of claim 2, wherein the repository includes a plurality of storage bays, wherein the electronic device is stored in a first storage bay prior to retrieval by the remove-and-place system, and wherein the second electronic device is stored in a second storage bay after being disengaged from the object or the second object by the remove-and-place system.

4. The system of claim 1, wherein the aerial placement position is atop a streetlight luminaire and wherein the remove-and-place system is further operable to:
rotationally engage a connector of the electronic device into a socket located atop the streetlight luminaire to secure the electronic device to the object.

5. The system of claim 4, wherein the remove-and-place system is further operable to apply a controlled force to the electronic device in a direction toward the socket while rotationally engaging the connector of the electronic device into the socket.

6. The system of claim 1, wherein the remove-and-place system is further operable, after the autonomous placement device has been positioned aerially by the UAV, to:
fasten to a second electronic device having a connector that is rotationally engaged in a socket located atop a streetlight luminaire of a utility pole; and
rotationally disengage the connector of the second electronic device from the socket.

7. The system of claim 1, wherein the autonomous placement device further includes:
a memory; and
a processor operable to execute software instructions stored in the memory to:
direct the remove-and-place system to locate the aerial placement position;
direct the remove-and-place system to retrieve the electronic device from the repository; and
direct the remove-and-place system to secure the electronic device to the object at the aerial placement position.

8. The system of claim 1, wherein the payload coupling system is integrated with one of the UAV and the autonomous placement device.

9. The system of claim 1, further comprising:
a guidance system operable to locate the aerial placement position prior to securing of the electronic device to the object by the remove-and-place system.

10. The system of claim 1, wherein the autonomous placement device further includes:
a propulsion system arranged to position the remove-and-place system proximate the aerial placement position.

11. The system of claim 1, wherein the remove-and-place system includes:
at least one clamping structure arranged to clamp the electronic device at least during retrieval from the repository.

12. An autonomous placement device comprising:
a repository arranged to store at least one electronic device;
a guidance system operable to locate an aerial placement position; and
a remove-and-place system operable to retrieve an electronic device from the repository, secure the electronic device to an object at the aerial placement position, and release the electronic device after the electronic device is secured to the object.

13. The autonomous placement device of claim 12, further comprising:
a housing; and
a coupling system arranged to mechanically couple the housing to an unmanned vehicle.

14. The autonomous placement device of claim 12, wherein the electronic device is a lighting control device, a small cell, a distribution transformer monitor, a tilt sensor, or an environmental sensor.

15. The autonomous placement device of claim 12, wherein the guidance system includes:
a surveillance engine configured to collect data in an area around the object; and
an artificial intelligence engine to identify the aerial placement position from the data collected by the surveillance engine.

16. The autonomous placement device of claim 15, further comprising:
a propulsion system responsive to the guidance system and operable to position the remove-and-place system proximate the aerial placement position.

17. The autonomous placement device of claim 12, wherein the aerial placement position is atop a streetlight luminaire and wherein the remove-and-place system is further operable to apply a controlled force to the electronic device in a direction toward a socket located atop the streetlight luminaire and rotationally engage a connector of the electronic device into the socket to secure the electronic device to the object.

18. A method for securing an electronic device to an object at an aerial placement position, the method comprising:
loading a repository of an autonomous placement device with the electronic device;
coupling the autonomous placement device to an unmanned vehicle;
remotely controlling the unmanned vehicle to transport the autonomous placement device to the aerial placement position; and
directing the autonomous placement device to retrieve the electronic device from the repository and secure the electronic device to the object.

19. The method of claim 18, further comprising:
surveilling the area around the object prior to remotely controlling the unmanned vehicle to transport the autonomous placement device to the aerial placement position; and
establishing at least one fiducial marker to guide at least one of the transport of the autonomous placement device to the aerial placement position and the directing of the autonomous placement device to secure the electronic device to the object.

20. The method of claim 18, further comprising:
removing, by the autonomous placement device, a second electronic device from the object; and
storing, by the autonomous placement device, the second electronic device in the repository after removal from the object.
